(19) United States
(12) Patent Application Publication
(10) Pub. No.: US 2024/0377790 A1
(43) Pub. Date: Nov. 14, 2024

(54) LUXURY SMARTWATCH DEVICE

(71) Applicant: YORAM GHASSABIAN, Great Neck, NY (US)

(72) Inventor: YORAM GHASSABIAN, Great Neck, NY (US)

(21) Appl. No.: 18/691,881

(22) PCT Filed: Sep. 23, 2022
(86) PCT No.: PCT/US2022/076895

§ 371 Date: Mar. 13, 2024

Related U.S. Application Data
(60) Provisional application No. 63/248,612, filed on Sep. 27, 2021.
(60) Provisional application No. 63/391,360, filed on Jul. 22, 2022.

(51) Int. Cl. G04G 17/08; G04G 17/02; G04G 21/00

(52) U.S. Cl. CPC G04G 17/08; G04G 17/02; G04G 21/00

(57) ABSTRACT

A smartwatch device comprising a smartwatch unit having a screen and a housing to accommodate at least a number of components of said smartwatch unit, wherein said housing has a cover to cover at least a portion of said screen and wherein said cover is openable and/or closable, and wherein said cover has a window so that when said cover is in closed position, the corresponding portion of the screen is visible to a user, and wherein said cover includes a physical watch dial, and wherein said smartwatch unit has at least two display units wherein a first display unit is dedicated to display virtual watch hands when said cover is in closed position so that combination of said physical watch dial and said virtual watch hands show time.

### CROSS REFERENCE TO RELATED APPLICATIONS

This application claims priority of the following earlier applications:

U.S. Provisional Application 63/391,360 filed on 22/07/222, and

U.S. Provisional Application 63/248,612 filed on 27/09/2021.

The contents of applications 63/391,360 and 63/248,612 are hereby incorporated by reference.

### BACKGROUND OF THE INVENTION

Smartwatch is an electronic device that can hardly replace a traditional and/or luxury watch on the wrist. A number of attempts to produce and promote smartwatch by electronic device manufacturers have been provided but the smartwatch has never become mainstream like a wristwatch because of several factors such as its appearance, the life of the battery, etc. In fact, unlike the traditional wristwatch, the screen of a smartwatch is most of the times turned off automatically to save power or many times turned off because the power source (e.g. herein may be referred to as the battery) is empty making the current smartwatches unusable and therefore undesirable by most of the public. In order to become mainstream, a smartwatch must become a luxury item resembling to a traditional wristwatch and preferably be distributed by watch, jewelry and fashion manufacturers and/or channels. For such purpose, preferably, the technology manufacturers (e.g. OEMs, ODMs) may produce smartwatch components and the corresponding software (e.g. Operating System) preferably in form of a module/unit and the watch/fashion manufacturers preferably may dress said module/unit by accommodating it within a luxury envelope/case (e.g. herein may be referred to as a box) by giving to the combined module and box the appearance of a luxury wristwatch which functions like a smartwatch. Such a combined product may herein be referred to as a luxury watch or a smartwatch device.

### SUMMARY OF THE INVENTION

In order to become popular, smartwatch must have a traditional and/or luxury (wristwatch) appearance. This issue is being addressed in this patent application. In this patent application a number of principles are described and shown through exemplary figures and descriptions. It must be noted that other examples and/or products based on principles described herein may be considered by people skilled in the art.

According to an exemplary aspect, at least most (preferably, all) of the components (e.g. hardware and/or software) of a smartwatch (e.g. herein may also be referred to as smartwatch mechanism, smartwatch module, smartwatch unit, smartwatch system, etc.) preferably in form of a module is integrated within a watch box (e.g. having a housing) to accommodate said smartwatch system and a cover that preferably includes a (e.g. traditional/physical/hard) wristwatch dial (e.g. herein may be referred to as a disc. For simplification purpose, a hole in the disc may herein be referred to as a hole in the cover). Preferably, the smartwatch system includes a display unit (e.g. herein may be referred to as a screen) to display at least the virtual hands of a watch face and/or any of the other output contents of the smartwatch system. Preferably, the disc has a hole/window so that, when the cover is in closed position, at least a portion of the (e.g. surface of the) display unit of the smartwatch system is visible to a user. According to a preferred method, when the cover is in closed position, an output content of the smartwatch is directed/printed in said visible portion of the display unit. In this case according to one method, preferably, the rest (e.g. the covered portion) of the display unit is turned off to save power.

Preferably, when the cover is in closed position (e.g. after closing the coved), the smartwatch system may display a first output content such as a virtual watch hands on the screen so that the combination of the physical watch dial and the virtual watch hands show (e.g. the current) time.

According to a preferred embodiment, said first output content is a selected/specific content of or related to an application that is adapted/directed to be displayed on the portion of the display unit of the smartwatch that corresponds to the size and/or location of a hole/window within the cover (e.g. such content may herein be referred to as “directed output content”). Said directed output content may be displayed on the screen automatically or manually (e.g. upon accomplishment of a condition) before and/or after closing the cover. For example, said directed output content may be displayed on the screen upon closing the cover, at a predefined lapse of time after closing the cover, upon a user's predefined interaction (e.g. upon pressing a physical button such as a side button of the smartwatch), etc.

With continuous description of the current embodiment, upon/after opening the cover, the system automatically or the user manually may (e.g. remove the directed output content which is displayed on the screen and) display a second (e.g. different/new) output content (e.g. herein may be referred to as the/a “principal” output content) having a different form factor (e.g. occupying a larger portion of the screen, or occupying at least substantially the whole screen, etc.) and/or being displayed anywhere on the (e.g. entire) screen (i.e. regardless of (e.g. the location of) a/the/said window in the cover). Said different/new output content may be related or unrelated to the directed output content. As an example, said different/new output content may be an output content related to said directed output content displayed in a different form factor (e.g. in a larger scale (e.g. larger size) in comparison to the size of the window, in a larger scale (e.g. larger size) in comparison to the size of the visible portion of the screen (e.g. when the cover is closed), on another location on the screen, reformatted, etc.). (e.g., and/or regardless of (e.g. the location of) a/the/said window in the cover).

According to another example, said different/new output content may be an output content unrelated to said directed output content displayed in a different form factor (e.g. in a larger scale (e.g. larger size) in comparison to the size of the window, in a larger scale (e.g. larger size) in comparison to the size of the visible portion of the screen (e.g. when the cover is closed), on another location on the screen, reformatted, etc.). In this case, preferably, the first and second output contents are independently from each other displayed on the screen (e.g. each of said first and second contents corresponds to a different application.). As an example, the second output content is a virtual watch hands related to a time application, and the first output content is related to a messaging application.

According to one method, different (e.g. types of) interactions may switch the system into different modes and accordingly may system may preferably display different output contents on the screen or remove most/all of the contents from the screen (e.g. turning the screen off). As an example, a first pressing action on a (e.g. side) button of the smartwatch may result in displaying a directed output content on the screen, a second (e.g. similar or different) pressing action on a (e.g. side) button of the smartwatch may result in displaying a principal output content on the screen, a third (e.g. similar or different) pressing action on a (e.g. side) button of the smartwatch may result in turning off the screen, etc. Note that this is an example and that the type and or order of interactions may vary.

As an example, when the cover is in closed position and a notification relating to an incoming SMS message is directed and displayed on the corresponding portion on the screen, upon opening the cover, the notification may disappear and at least a portion of the incoming message may be displayed (e.g. in a large scale, using a large font, on at least a substantial portion of the screen, etc.) on the screen.

According to another example, when the cover is in closed position and small watch hands are directed and displayed on the corresponding portion on the screen, upon opening the cover, said small watch hands are preferably removed and an (e.g. a large) interface/content relating to another application (e.g. a predefined application, a focused application, etc.) running within the smartwatch unit may be displayed on the screen.

Preferably, the smartwatch system automatically recognizes that the cover is in closed position or in open position. Alternatively, the user informs the smartwatch system that the cover is in closed position or is in open position, by for example providing an (e.g. a predefined) interaction. When the cover is in open position, preferably, the output content of the smartwatch system (e.g. an output of at least one of a number of applications running/focused within said smartwatch unit) may be printed/displayed in a larger scale and/or anywhere on the display unit.

Preferably, said display unit is a touch screen. Optionally, said display unit is not touch sensitive. Note that in this patent application the terms “display unit” and “screen” are preferably/usually used for the same meaning/purpose.

Preferably, the cover is openably and closably attached to the housing of the box. Preferably, a hinge is used to permit opening or closing said cover. Optionally other opening and closing means (e.g. a sliding means) are used for the same purpose.

Preferably, when the cover is in closed position, a/the visible portion of the display unit displays a watch face (e.g. in reduced size in accordance with the size of the corresponding hole in the cover). Preferably said watch face is the dynamic virtual hands of a watch (e.g. that move/rotate according to the time). Preferably, the physical disc includes at least a portion of an interface such as a dial component of a wrist watch so that the combined smartwatch module and the box (e.g. the luxury watch (surface)) resemble to a traditional (e.g. wrist) watch displaying time.

Optionally, said virtual watch face also displays the rest of a virtual watch face (e.g. also displays a virtual watch dial and/or more).

The smartwatch device may have a system dedicated/related to (e.g. controlling) time (e.g. calculating time such as the current time, receiving time from the internet and processing it, providing time, displaying time, etc.). Such a system may herein be referred to as the time system.

The smartwatch system includes a battery power source (e.g. the battery relating to at least most of the functionalities of the smartwatch system). Said battery, herein, may be referred to as the main battery, the smartwatch system battery, etc.).

Preferably, an additional battery power source (e.g. herein may be referred to as the watch battery, or the time system battery) separately from said main power source of the smartwatch system is used by the components of the time system. As an example, said time system battery may provide power to display time on the screen of the smartwatch device in general and in the portion of the screen corresponding to the hole of the cover in particular. Generally, time system battery power source lasts much longer than said main power source the time system functions are preferably manly restricted to time. Alternatively, the main power source may supplies power to display any content (e.g. notifications) including time content (e.g. watch face/hands/dial, etc.).

According to one embodiment, the main battery provides power to the time system. In this case, optionally, if the remainder power of the main battery's power is less than a predefined quantity such as, for example, less than 20 percent of the full power of the main battery (e.g. herein may be referred to as when the battery is weak), then the main battery stops to provide power to the smartwatch system (e.g. smartwatch system, including but not limited to a (e.g., preferably, all of) its communication system/s is/are automatically turned off) and the remainder power of the main battery is used to supply power to the time system (e.g. permitting the smartwatch device to continue to show time for a very long period of time). In this case, according to one aspect, a/the time system (e.g., of the smartwatch) may preferably calculate a (e.g., current) time based on one (e.g., preferably, the last) time that smartwatch received a (e.g., current) time from a remote server (e.g., from the internet). According to another aspect, a first (e.g., a current) time may be entered/provided to the smartwatch (e.g., manually) by a user and the time system may preferably calculate a second (e.g., current) time and display it on the screen.

Note that, optionally, a user may be permitted (e.g., by the smartwatch system) to turn off (e.g., disable) the smartwatch system and (e.g., thereafter, automatically or manually) turn on (e.g., enable)/maintain (e.g., only) the time system.

Note that the main battery may be the only battery power source of the smartwatch device.

According to one aspect, when the main battery is weak or empty, or when the smartwatch system is turned off, or when the main display unit is turned off, the main processor may preferably process the tasks related to the time system only.

It is therefore the purpose of this patent application to provide principles and methods to produce wrist-mounted and none wrist-mounted devices that have the appearance of a traditional (e.g. wrist) watch (e.g. when the cover is closed) and the appearance and functionality of a smartwatch (e.g. when the cover is open).

### BRIEF DESCRIPTION OF THE DRAWINGS

FIGS. 1-6, show some principles of integrating a smartwatch module within a box in accordance with different exemplary embodiments of the invention;

FIGS. 7-8, show some principles of using a button for informing a smartwatch (operating) that the cover is in open position or in closed position in accordance with different exemplary embodiments of the invention;

FIGS. 9-10, show some principles of position signs that show time within a cover in relation to accordance with the position of a window within the cover in accordance with different exemplary embodiments of the invention;

FIGS. 11-17, show some principles of displaying contents on the screen of a smartwatch device in accordance with the window/hole of the cover of a box according to different exemplary embodiments of the invention;

FIGS. 18-21, show some principles of displaying time on the visible portion of the display in accordance with the watch dial of the cover of a box according to different exemplary embodiments of the invention;

FIGS. 22-27, show some principles of integrating a smartwatch module within a box in accordance with different exemplary embodiments of the invention;

FIG. 28, show some principles of integrating a smartwatch module within a box in accordance with a different exemplary embodiment of the invention;

FIGS. 29-30, show some principles of integrating a smartwatch module with a cover openable and/or closable in a non-planar manner in accordance with a different exemplary embodiment of the invention;

FIGS. 31-34, show some principles of a smartwatch having a cover which is openable and/or closable in a planar manner in accordance with a different exemplary embodiment of the invention;

FIGS. 35-45, show an exemplary alerting means/system integrated within a device such as a smartwatch having a cover for informing an operating system of the device about the position (e.g. open, closed) of the cover in relation to the housing of the device, in accordance with an exemplary embodiment of the invention;

FIGS. 46-51, show a system for opening and closing a cover of a device such as a smartwatch, in accordance with an exemplary embodiment of the invention;

FIGS. 52-54, show a system for opening and closing a cover of a device such as a smartwatch, in accordance with an exemplary embodiment of the invention;

FIGS. 55-58, show some principles of integrating an entire smartwatch system within a box in accordance with different exemplary embodiments of the invention;

FIGS. 59-60, show some principles of integrating a glass within a cover in accordance with different exemplary embodiments of the invention;

FIGS. 61-62, show some principles of a first type of integration of two separate/independent displays within the smartwatch device in accordance with different exemplary embodiments of the invention;

FIGS. 63-64, show some principles of a second type of integration of two separate/independent displays within the smartwatch device in accordance with different exemplary embodiments of the invention;

FIG. 65, shows some principles of a third type of integration of two separate/independent displays within the smartwatch device in accordance with different exemplary embodiments of the invention;

17 FIG. 66-70, are used to demonstrate the advantage of the current invention, in accordance an exemplary embodiments of the invention.

### DETAILED DESCRIPTION OF THE INVENTION

According to one embodiment of the invention, the components of a smartwatch system preferably in form of a smartwatch module unit/module can be implemented within a (e.g. luxury) box (e.g. herein may be referred to as a watch box or box) preferably having a wrist watch appearance. The components of the smartwatch system may preferably be in form of a smartwatch module and may include a display unit (e.g. a touch screen). Said components may preferably be removably inserted within and/or extracted from the watch box. Preferably, the smartwatch unit and the watch box can be manufactured separately. The watch box may have a base/housing to preferably accommodate at least most of the components the smartwatch system (e.g. the smartwatch module), and a cover. The smartwatch module may be accommodated/fixed within the housing by using any type of accommodation means/fixture. The watch box may preferably have a cover to cover at least a portion of the surface of the display unit of the smartwatch. Preferably, the cover of the watch box may have at least one hole. Preferably, at least a portion of the display surface of the smartwatch may be visible and/or accessible (e.g. responding to a touch) (e.g. through the/a corresponding hole) to the user while the smartwatch is preferably is covered by said box cover.

The smartwatch module can have any shape and/or any size. An attachment/fixing component may be used within the housing and/or with the smartwatch unit to attach/fix the smartwatch unit within the housing.

Preferably, the (e.g. the external) side of the cover of the watch box is designed such that to resemble to/have a conventional (e.g. wrist) watch unit design preferably having at least a (e.g. preferably mechanical/hard) watch dial. Preferably, when the cover is in closed position, the smartwatch display unit may display output contents (e.g. of the smartwatch) such as a virtual watch face, the movable virtual hands related to showing time, notifications, date, pictures, video, text, etc. through a (e.g. one or more) on the portion of the display surface corresponding to a (e.g. one or more) hole of the cover so that a user can see and or interact with said portion of the display surface. Preferably, the size and the location of an output content is such that to match (e.g. approximately, at most) the size and/or the location of the hole so that to (e.g. preferably entirely, optionally partially) be visible/accessible through said hole. The virtual watch face/hands may have any design and can be interchanged automatically upon an event or manually by a user. At any instant, the system automatically and/or the user manually may be able to select/change the virtual watch and/or a content among a number of choices (e.g. among a number of watch faces/hands and/or other contents) (for example by touching (e.g. tapping on, gliding on, etc.) the display surface (e.g. through the hole), by flicking the watch/wrist, etc.

By combining the beauty of a traditional/physical watch dial within the watch cover and a virtual watch face/hands which is visible through the/a hole, a beautiful and/or luxury smartwatch device may be created. For example, the cover and/or housing may have antic design, may be made from precious materials (e.g. gold), include precious stones (e.g. diamonds), etc.

Note that, the/an uncovered portion of the display surface (e.g. visible and/or accessible through a hole) may also display any one or more other contents such as notifications, messages, pictures, videos, etc.

According to one embodiment, a user may interact with the uncovered portion of the display unit (e.g. the portion visible and/or accessible through the/a hole) to access the (e.g. corresponding) content displayed (e.g. displayed on said portion) on the screen. As an example, the user may interact with said uncovered portion to change the content displayed on it. For example, such interaction may result in changing/scrolling watch faces/hands (e.g. by sliding on said portion of the display/touchscreen), removing a notification displayed on the uncovered portion (e.g. by tapping on said portion), opening a message corresponding to a notification appeared/displayed on said uncovered portion, etc. According to one method, the content displayed on said portion may vary based on one or more conditions/events. As an example, by default said portion may display a virtual watch hands/face and when a notification arrives it may replace or be added to said watch hands/face (e.g. for a while). Optionally, for example, said notification may be printed within (e.g. above) the virtual watch hands/face within said portion of the display surface.

The cover may have more than one hole. It can have multiple holes (e.g. several holes, a grid shape cover, etc.) all having the same shape and/or any of them may have a different shape, size, etc. (e.g. when the cover is in closed position) This may give a beautiful live appearance to the luxury smartwatch watch. For example, the display unit of the smartwatch unit may display different one or more colors (e.g. over time, manually or automatically) and/or backgrounds giving the watch box/cover device a live appearance (e.g. colors can be seen through at least some of said holes). The user may select the color/s of the display for such purpose. Selecting any content such as color, background design, etc. of the display may be made automatically by the system and/or manually by the user (e.g. for example by interacting with (e.g. touching/sliding on) the display (e.g. through the hole), by flicking the smartwatch, user's corresponding wrist, etc.).

If the cover has several holes, according to one method, preferably at least each of one or more of said holes may be related to a different content on the screen.

When the cover is in open position, substantially/practically the entire display unit may become available. The smartwatch system may display any content dedicated to the smartwatch preferably on a large scale and/or anywhere on the screen. For example, the user may use any application such as a browser, a messaging application to see messages, type messages on an on-screen keyboard displayed on the display unit of the smartwatch, receive and send messages, view pictures or videos, etc. The term “any application may mean at least one of at least two applications running on the screen and providing/displaying a content on the screen. Said application may be activated upon a manual (e.g. an arbitrary) interaction by a user or automatically by the system of the device/smartwatch. Note that the smartwatch module can have any shape and/or size.

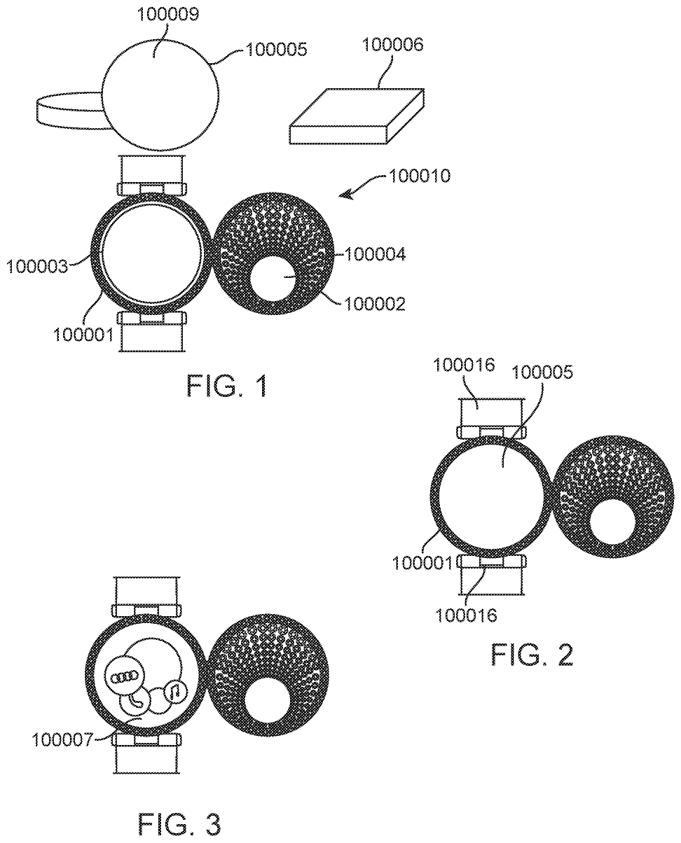

FIGS. 1-5 show examples of the principles described herein. FIG. 1 shows a number of smartwatch units/modules, including a round one 100005 having a display unit (e.g. a touch screen) 100009 and a square one 100006 also having a display unit. FIG. 1 also shows a watch box 100010 having a housing 100001 and a cover 100002. The housing has accommodate means 100003 to accommodate a smartwatch module 100005 and the cover has a hole 100004. In this example, the cover is shown in open position.

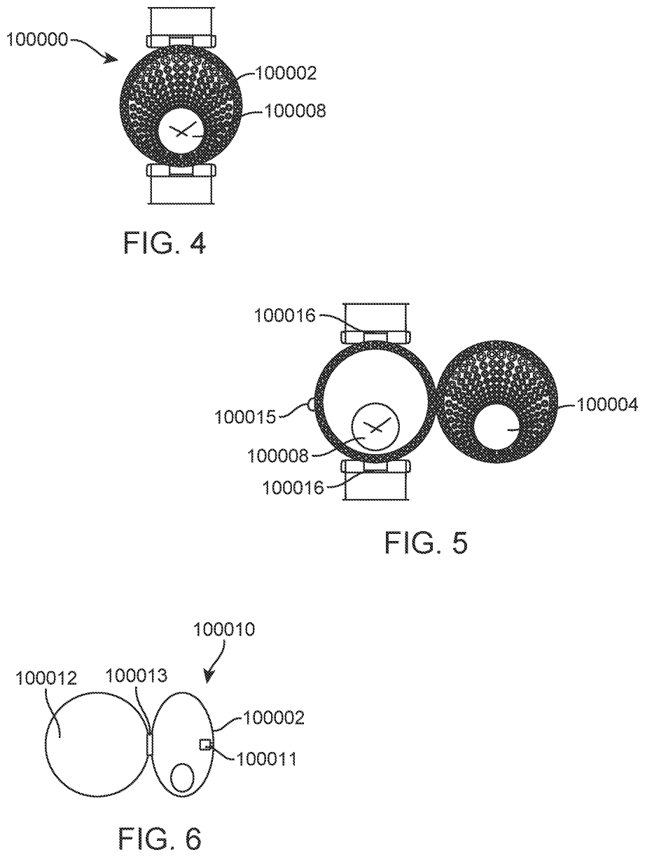

In FIG. 2, the/a smartwatch module 100005 is accommodated within the housing 100001. As shown in the example of 3, (e.g. preferably when the cover is in open position) substantially the entire screen/surface of the display of the smartwatch unit is used to display contents 100007 on the screen. FIG. 4 shows the luxury smartwatch (e.g. the box including the smartwatch unit/module. Herein may be referred to as the luxury smartwatch) 100000 wherein the cover 100002 is in closed position. As shown here, when the cover 100002 is in closed position the system may preferably (e.g. after a predefined lapse of time of not using the smartwatch and/or not interacting with the (touch) screen, etc.) automatically display a (e.g. another) content (e.g. a virtual watch face/hands) 100008 corresponding (e.g. in a small scale) to a/the hole/s 100004 of the cover so that to be visible and/or accessible to the users. As mentioned before, as demonstrated in FIG. 5, the user can/may also manually cause the system to provide (e.g. print on the screen) such content/s 100008 dedicated to the hole/s 100004 (e.g. before and/or after closing the cover). As an example, the virtual watch hands 100008 may be directed to and/or displayed on the portion of the screen that corresponds to the hole 100004 in the cover based on a predefined interaction such as after closing the cover, upon pressing on a physical button (e.g. for example, upon pressing the side button 100015) of the smartwatch (e.g. before or and/or after closing the cover), etc. Note that in this example, the housing of the box is attached to a strap 100016 by hinges.

According to one embodiment, preferably by default, the content displayed on the uncovered portion (e.g. corresponding to a hole within the cover) of the display unit of the smartwatch module may be adapted to the size of the hole and/or to its location. An interaction such as a (e.g. long) pressing action on said portion/content (e.g. while the cover is in open position or in close position) may enlarge the size of the said content and/or may provide another (e.g. enlarged) (e.g. related or unrelated) content on the screen (e.g. or vise versa).

Alternatively, the principles just described may be applied to an automated system wherein when the cover is in closed position, a second content preferably in a reduced size is displayed on the portion of the screen that corresponds to a hole, and when the cover is in open position, a first content (e.g. related or optionally unrelated to said second content) is displayed preferably in a larger scale and/or in any location on the screen. As an example, said second output content may be an interface of a messaging application and said first output content maybe the virtual watch hands for showing time.

According to one embodiment, when the cover of the smartwatch device is in open position, preferably, a first output content displayed on the display/screen of the smartwatch substantially covers the entire surface of the display/screen of the smartwatch. Accordingly, upon closing said cover, preferably, another output content which is not related to said first output content, is displayed on said display/screen wherein said another output content covers a substantial portion (e.g. the entire) surface of the display/screen of the smartwatch. And vise versa.

According to one embodiment, when the cover is in open position, a first type of content is printed on a substantial portion (e.g. all) of the surface of the screen of the smartwatch and wherein when the cover is in closed position, a second type of content, which is not related to said first type of content, is printed on a/said substantial portion (e.g. all) of the surface of the screen of the smartwatch.

Note that the watch box may have additional/more than one holes (e.g. in the cover and/or or in the housing of the box (e.g. for access to the charger, camera, microphone, side button, etc.) of the smartwatch unit.

The cover of the watch box may be opened and closed by using any type of means such as hinges, sliding components, rotating means, etc.

Preferably, the display surface of the smartwatch is a touch sensitive (e.g. a touch screen).

Note that any kind of alerting means may be used to inform the smartwatch system that the cover is in open or close position. For example, an optical means, a sensor, a node, etc., may be integrated with the smartwatch unit and/or with the watch box (e.g. cover).

According to one aspect, a touching action (e.g. including or excluding pressure) or untouching action of an element/portion of the cover with an element/portion of the housing may be used for informing the smartwatch (e.g. operating) system about the status of the position of the cover (e.g., respectfully, closed position or open position) in relation to the housing. As an example, when a predefined portion of the cover touches a predefined portion of the housing, a first predefined signal is sent to the smartwatch system and is interpreted by the smartwatch system as the cover is/become/being closed. Accordingly, when the cover is opened, a second predefined signal is sent to the smartwatch system and is interpreted by the smartwatch system as the cover is/become/being opened.

According to one exemplary aspect, the inside face of the cover may include a node such that when the cover is in closed position the node touches or is very close to a component (e.g. the touch screen) of the smartwatch unit (e.g. at a predefined location) to inform the (e.g. the operating system of the) smartwatch unit that the cover is closed. Accordingly, when the cover is opened, the node may preferably not touch said component or it may not be close to it, informing the smartwatch system that the cover is open position. Note that the node is preferably made of materials that the touchscreen can sense it (e.g. when it touches the touchscreen or when it is very close to the touchscreen).

Preferably the smartwatch screen is a capacitive touchscreens Preferably, the case of the smartwatch is made of conductive materials (e.g., metals), Preferably, the node is made from conductive materials such as copper, aluminum, thermal paste, etc. Preferably, the tip of the node may include a (e.g., silicone) rubber tip which has carbon black. Alternatively, the node may be made of rubber which has carbon black. A conductive (e.g., silicone) rubber node (e.g. tip) may work well because it is conductive (but not very) and can cover an enough large area (e.g, due to being squashy) so that the touchscreen can sense an interaction with it. Alternatively, other types of materials may be used for the same purpose.

As an example, FIG. 6 shows a/said luxury smartwatch 100010 wherein its cover 100002 is in an open position. As shown, the inside face of the cover includes a node 100011 that may touch (e.g. or may be close to) the screen 100012 of the smartwatch unit when closing the cover. In this example, a hinge 100013 is used for opening and closing the cover.

According to one embodiment, a (e.g. an optical, a movement detection, etc.) sensor may preferably be integrated within the smartwatch device (e.g. within the smartwatch system, or within inside of the cover, or in another appropriate location inside or outside the box, etc.). Said sensor may be related to a processor that is adapted to calculate (e.g. the degree of) the light that the sensor or a corresponding means detects/receives and accordingly the processor is adapted to recognize/determine if the cover of the box is in (e.g. substantially) open position or in a (e.g. substantially) closed position. As an example, if the sensor detects/receives less than a predefined amount of light, accordingly, the processor considers/determines that the cover is in closed position. Also as an example, if the sensor detects/receives more than a predefined degree of light, accordingly, the processor considers/determines that the cover is in open position.

Based on the above-mentioned principle, other types of alerting systems may be used for alerting/informing the operating system of the smartwatch device about the position status (e.g., open position or closed position) of the cover in relation to the housing. According to one embodiment, the cover and/or the housing may be designed such that when a user closes the cover of the housing, a (e.g. side) button of the smartwatch may preferably, become pressed (e.g. by the cover) and based on that a (one or more) signal is transmitted to the smartwatch (e.g. operating) system to inform it that the button is pressed. Consequently, according to one method the smartwatch system may consider that the cover is closed. According to another method, in order for the smartwatch system to consider that the cover is closed, said button should remain pressed for at least a predefined lapse of time). According to one aspect, as long as said (e.g. side) button remains pressed, the smartwatch system considers that the cove is closed position.

With continuous description of the current embodiment, when a user opens the cover of the housing, a (e.g. side) button of the smartwatch may preferably become released (e.g. by the cover) and based on that a (one or more) signal is transmitted to the smartwatch (e.g. operating) system to inform it that the button is released. Consequently, according to one method the smartwatch system may consider that the cover is opened. According to another method, in order for the smartwatch system to consider that the cover is closed, said button should remain pressed for at least a predefined lapse of time). According to one aspect, as long as said (e.g. side) button remains released, the smartwatch system considers that the cove is in open position.

With continuous description of the current embodiment, when the (e.g. side) button is in released position (e.g., for example by opening the cover) for at least a predefined lapse of time, the system may consider that said cover is in open position and, accordingly, the smartwatch system displays an (e.g., on or more) output content of the smartwatch in relation with the position/location of the window of the cover on the screen (e.g., I other words, according to window's position within the cover). Accordingly, when the (e.g. side) button is in pressed position (e.g., for example by closing the cover) for at least a predefined lapse of time, the system may consider that said cover is in closed position and, accordingly, the smartwatch system displays an (e.g., on or more) output content of the smartwatch regardless of the position/location of the window within said cover.

Note that, according to one example, the smartwatch system may consider that the cover is in closed position or in open position, immediately after said (e.g., side) button is, respectfully, pressed or released. In this case, said lapse of time is (e.g. approximately/practically) zero seconds.

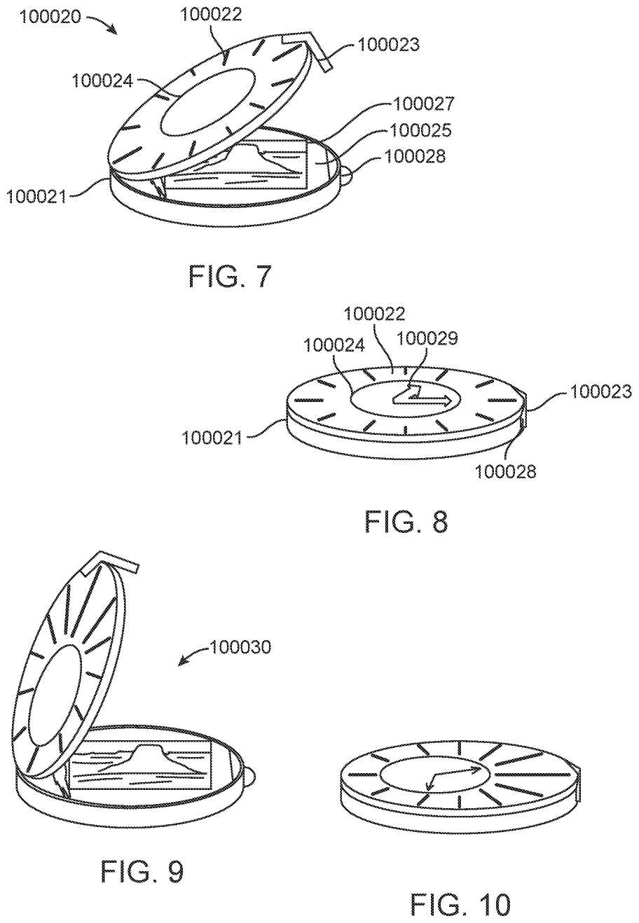

FIG. 7 shows as an example, a smartwatch of the invention 100020 having a housing 100021 within which at least some of the components of smartwatch mechanism including a display/screen 100025. A (side) button 100028 related to the smartwatch mechanism is disposed/integrated with the housing. When the cover is in open position, said button is in released position. Said housing 100021 has a cover 100022 being openable and closable, to cover said screen 100025. Said cover has a window 100024 as described. In this example, the cover is in open position. Accordingly, exemplary first output content 100027 of the smartwatch is displayed on practically the entire surface of the screen regardless of the location of said window within the cover or on the screen.

With continuous description of the current embodiment, the cover 100022 is designed to have an (e.g. integral) element/portion/form 100023. As shown in FIG. 8, when the cover is closed (e.g. by a user), said element/portion/form 100023 presses the button 100028 and keep it in pressed position. Accordingly, immediately and/or after a predefined lapse of time, the smartwatch system displays a second output content (e.g., movable virtual watch hands 100029) in accordance with (e.g. in relation to, by considering, adapted to, etc.) the location of the window 100024 on the screen (or within the cover).

The above-mentioned system can be generalized to any (e.g., other) type of device (e.g. including other types of smartwatch) for executing a first function when the button is kept pressed and executing a second function when the button is released.

According to one aspect, an on/off button (e.g., of an existing) smartwatch mechanism may be used as the (e.g., side) button with the embodiment described above, and the functionalities of said on/off button may be modified accordingly to at least conform with the principles described in said embodiment.

The above-mentioned embodiment is used to as an example to describe principles of using the touching action (e.g. including or excluding pressure) or untouching action of an element/portion of the cover with an element/portion of the housing for informing the smartwatch system about the status of the cover in relation to the housing. It is understood that any other alerting means/method may be used for informing the smartwatch system that the cover is in open position or in closed position based on said principle.

According to one method, pressing the button for less than a predefined lapse of time may be related by the smartwatch system to a first predefined function, and pressing the button for at more than said predefined of time may be considered by the system that the cover is in closed position. As an example, a first type of interaction with (e.g. a short (e.g., shorter than said predefined lapse of time) press-and-release action on) the (e.g. side) button 100028 may be related by a processor of the smartwatch (e.g. operating) system to navigating between interfaces of an application running within the smartwatch and/or within the elements/controls of an interface of an application running within the smartwatch and/or within a menu, etc. Also as an example, a second type of interaction (e.g., a short (e.g., shorter than said predefined lapse of time) double/triple press-and-release action on) the (e.g. side) button 100028 may be related by a processor of the smartwatch (e.g. operating) system to turning off and/or turning on the smartwatch.

By providing a smartwatch system/device as described above wherein preferably the (e.g. accessible and/or visible portion of the) display unit of the device is preferably (e.g. substantially) smaller when the cover is in closed position than when the cover is in open position, a beautiful and practical smartwatch having a conventional (e.g. wrist) watch appearance may be created which may be greatly acceptable by public. Such a device can have a very large size and still be acceptable and/or pleasant to the eye (e.g. a traditional smartwatch with a large display (e.g. without cover) looks like a gadget and may not be acceptable by people).

FIG. 9 shows a smartwatch 100030 (with the cover in open position) similar to the smartwatch 100020 of FIG. 10 with the difference that, here, the window in the cover of the smartwatch 100030 is not positioned/located at the center of the cover. FIG. 8 shows said smartwatch 100030 with the cover in open position. The signs on the cover representing the hours are arranged such that (together with the cover) they form a dial that corresponds to the position of the virtual watch hands show time.

Note that the cover may also include a (e.g. at least one additional) traditional/conventional/physical/hard (e.g. wrist) watch (e.g. to show time, chronometer, etc.) that functions regardless of/independently from the smartwatch system/module.

Preferably, the cover of the box may be detachable from the housing so that different covers may be interchangeably attached to/used with a same watch housing, or vise versa.

Note that the principles described above may not be limited to a smartwatch. The box described herein may have any size and shape and be designed to incorporate any other (e.g. electronic) unit such as smartphone unit, etc.

According to one embodiment, a (e.g. one or more) predefined interaction with the watch box may control at least some (e.g. one or more) of the functions of the smartwatch and vise versa. As an example, the cover may have a physical crown wherein rotating said crown may for example be related to selecting an application, providing commands to an application (e.g. scrolling watch faces/hands to select one), etc. Also as an example, the processor of the smartwatch unit/module may control some (e.g. one or more) functions assigned to the (e.g. cover of) the watch box such as rotating the hands of the (e.g. physical) watch of the cover that show the time, etc.

According to one embodiment, (e.g. at least a portion of) the display unit of the smartwatch module may display a/some content in (e.g. visual) relationship with the cover (e.g. see FIG. 18 described later herein).

Note that any (e.g. one or several) uncovered portion of the screen may display one (e.g. same or different) or several contents (e.g. several notifications, watch hands and notification/s together, etc.) at the same time and/or at a different time.

According to one method, interacting with a first uncovered portion of the display may control the content of a second uncovered portion of the display.

Some of the principles described herein are demonstrated in several drawing hereafter:

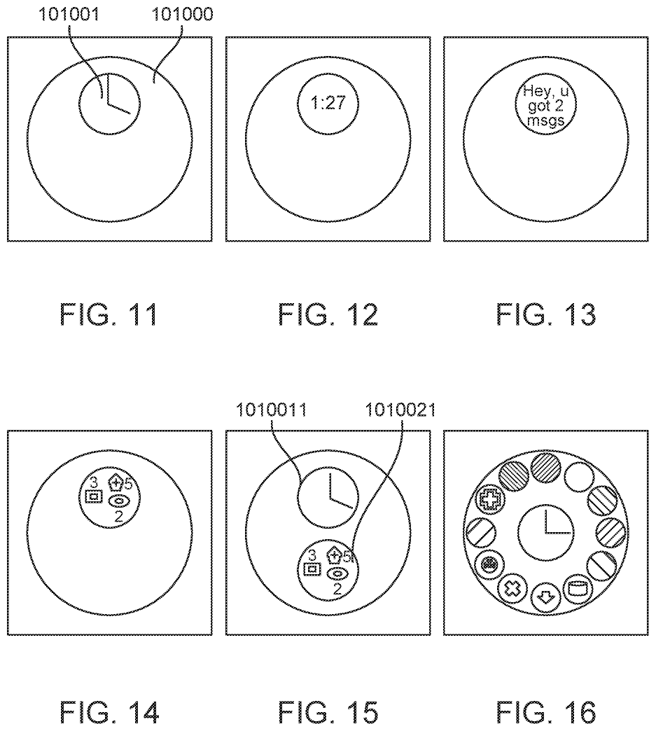

FIG. 11 shows the cover 101000 of a watch box in the closed position. In this example, a portion of the display of the smartwatch unit is visible/accessible through the hole 101001. In this example, said portion displays a virtual watch (e.g. a virtual analog design). In FIG. 12 said portion displays another virtual watch (e.g. in this example, a virtual digital design). In FIG. 13, said portion displays a notification (e.g. just arrived and replaced the virtual watch). In FIG. 14, said portion displays a plurality of notifications.

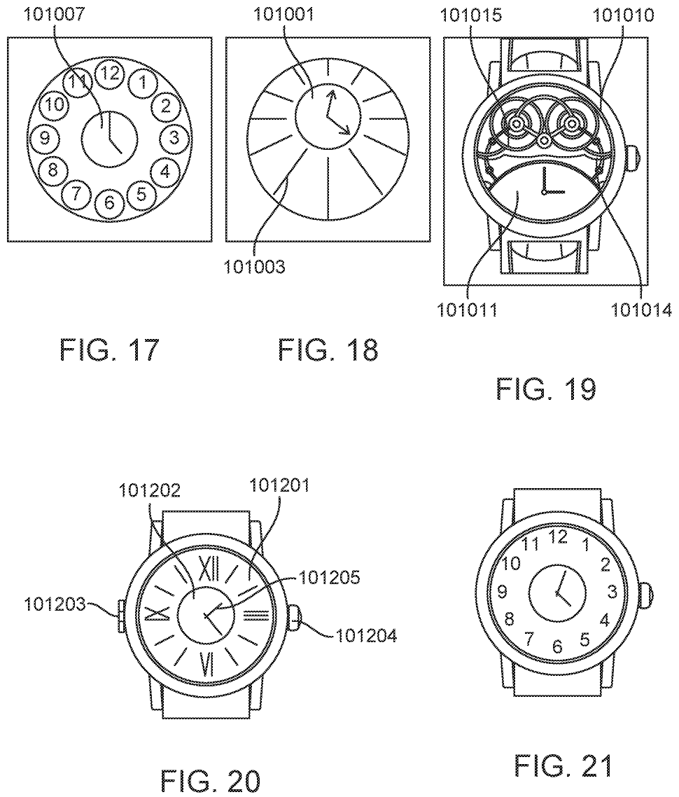

FIG. 15 shows the cover of a box having two holes 1010011 and 1010021 each displaying a (e.g. one or more) different content. In FIG. 16 the cover of the box has many holes each assigned to a (e.g. one or more) different content of a same application or of a number of applications. Preferably, interacting with one of said contents may activate the corresponding content and/or another content. In the example of FIG. 17 a virtual watch face is displayed. In this example, the center portion of the display unit relating to the center hole 101007 of the cover displays a virtual watch hands and the surrounding portions of the display unit relating to the surrounding holes of the cover display virtual digits of a/said virtual watch.

The design of the (e.g. physical) cover (e.g. including at least a watch dial) and the virtual watch (e.g. face/hands) of the smartwatch may be such that (e.g. when the cover is in closed position) together they may emulate/simulate/look like/resemble/form a regular (e.g. conventional) (e.g. wrist) watch (face). In the exemplary FIG. 18, the uncovered portion 101001 of the display of the smartwatch (e.g. which is under/in the hole of the cover) displays a virtual watch (hands) and the dial portion of the cover has physical bars relating to hours (e.g. the bar 101003 relating to 6 o'clock). In this example, the bars correspond/are related to the hands of the virtual watch (e.g. to show time. In this example, 12:22 pm or 00:22 am).

Many other designs combining the cover and a virtual content displayed under a hole of the cover may be considered. In the exemplary FIG. 19, the cover 101010 includes (e.g. static) mechanical (e.g. dummy) hardware 101014 of a physical watch. In this example, the portion of the display of the smartwatch corresponding to the hole 101011 may display a virtual watch hands. A moving virtual content (e.g. 101015) simulating a portion of a mechanical/physical watch (e.g. rotating circles) may be displayed on the display of the smartwatch and be visible through many empty spaces/holes in the mechanical/hardware cover. According to one embodiment, said virtual content (e.g. combined with said cover and said hardware cover) may give the impression of a working mechanical watch.

FIG. 20, shows a luxury smartwatch having a (physical) hardware cover 101201 wherein the cover includes hard Roman numbers and bars (e.g. forming a hard/physical watch dial) preferably resembling to those of a traditional watch dials. Said cover is openably and closably attached to the housing of the watch box by using hinges 101203. In this example, preferably when the cover is closed position, at least a substantial portion of the display unit of the smartwatch module (e.g. preferably at least the portion of the display unit which is hidden under the cover) is preferably turned off to reduce the power consumption. In this case, preferably, principally only the visible portion 101202 of the display unit displays specific contents relating to a/some specific/selected functionalities, applications, etc., that are (re-) directed to said portion 101202 of the display unit (preferably) when the cover is in closed position. In the current example, said portion of the display (e.g. and preferably the entire display) is displaying (e.g. only) a (small) virtual watch hands 101205 which significantly saves power while in combination with the watch box (e.g. hard/physical) cover (e.g. including the hard watch dial) gives to the overall luxury watch (e.g. surface) the resemblance of a traditional watch (face/surface).

The content directed and/or displayed on the portion of the screen that corresponds to a/the hole in the cover based on a predefined interaction such as after closing the cover, upon pressing on a physical button (e.g. for example, upon pressing the side button 100015) of the smartwatch (e.g. before or and/or after closing the cover), etc. The virtual watch hands may be presented/directed to the visible portion of the screen upon a predefined interaction such as upon closing the cover, after a predefined lapse of time after closing the cover, upon pressing on the side button 101204 (e.g. before or and/or after closing the cover), etc.

Note that said specific contents may include any type of content such as for example, notifications received by the watch, a chronometer, date, a photo, a video, a text, an incoming call alert, etc. Note that based on a/some condition/s, at a different time, said (e.g. uncovered) portion of the display may show a different content and/or may show more than one content.

Note that said specific contents may be selected by a user or automatically by a corresponding system.

In FIG. 21, the watch cover includes a watch dial having (physical) numbers.

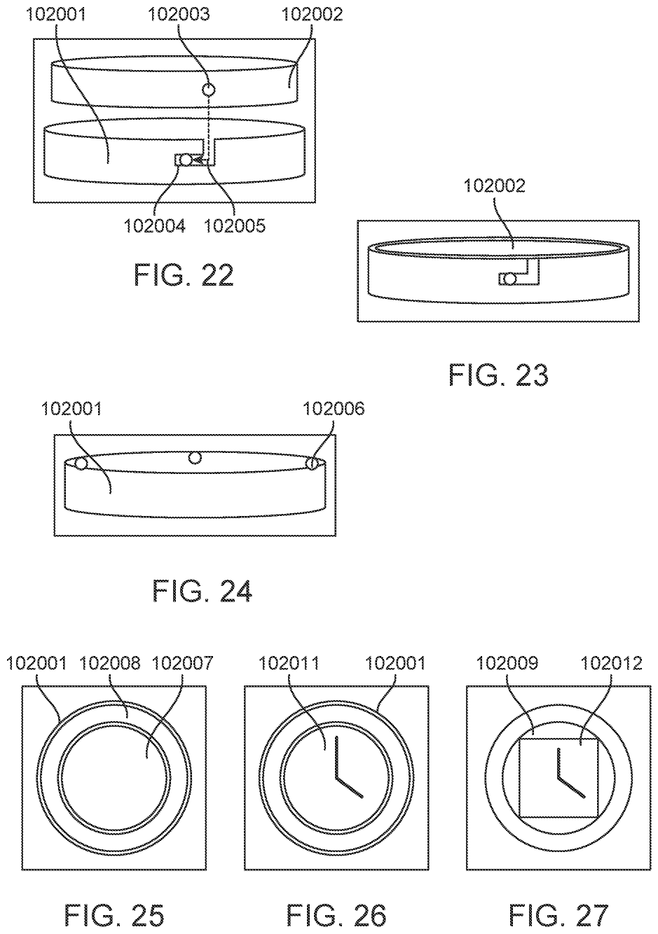

Different attachment means may be used to accommodate the smartwatch unit/module within a watch box. In the exemplary FIG. 22, the (e.g. wall of the) housing 102001 of a watch box includes an empty portion/hole 102004 having a specific shape so that to slide an external button 102003 of the smartwatch unit within it. By providing an action including pushing the smartwatch unit 102002 inside the housing in a manner to be able to slide the external button 102003 in said empty portion 102004 (e.g. see the direction arrow 102005) (e.g. and rotating the smartwatch in the housing), the smartwatch unit may be safely accommodated/fixed in the housing of the watch box. FIG. 23 shows the smartwatch unit 102002 after being accommodated in the housing of the box. Note that the smartwatch can be detached from the body by reversing said action.

FIG. 24 shows another example of a means to safely accommodate/fix the smartwatch unit in the housing of a watch box, In this example, the housing 102001 of the box may include (e.g. rubber) nodes (e.g. 102006) so that the user can push the smartwatch unit within the housing and the nodes keep it safely accommodated/fixed in the housing.

According to one embodiment, different types of smartwatch units may be integrated within a single smartwatch housing using an (e.g. one or more different) accommodating component. An accommodating component may be used to adapt a smartwatch unit within the housing of a box. For such purpose, according to one method, different accommodating means preferably having a unique (e.g. exterior) shape and/or size, and preferably having different accommodating housings (e.g. holes with different shape and/or size within said accommodating means) may be used to adapt/accommodate different smartwatch units within preferably a single watch box housing.

The accommodation means may preferably be removable and/or replaceable.

The exemplary FIGS. 25 and 26 show an accommodation means 102008 (e.g. made from rubber, plastic, etc.) used to accommodate a (e.g. small) round smartwatch unit 102011 within a larger round housing 102001 of a watch box. By implementing such an accommodation means 102008 in said housing 102001 a smaller housing 102007 is created within the original housing 102001. In the exemplary FIG. 27 the accommodating component 102009 is used to accommodate a square smartwatch unit 102012 within a/the round housing of a/the watch box.

Note that, the cover of the box may have a housing to accommodate at least a portion of the smartwatch unit/mechanism. In this case, preferably, when the cover is in closed position, the display component of the smartwatch unit may be located face to the user's wrist and in the open position, the display is preferably face to the user's face.

Note that preferably at least a portion of the bottom of the housing of the box may have a hole/be empty. This may have some advantages such as to permit to reduce the height/size of the watch box, to permit to extract the smartwatch from the housing of the box by pushing the smartwatch unit through said hole towards outside.

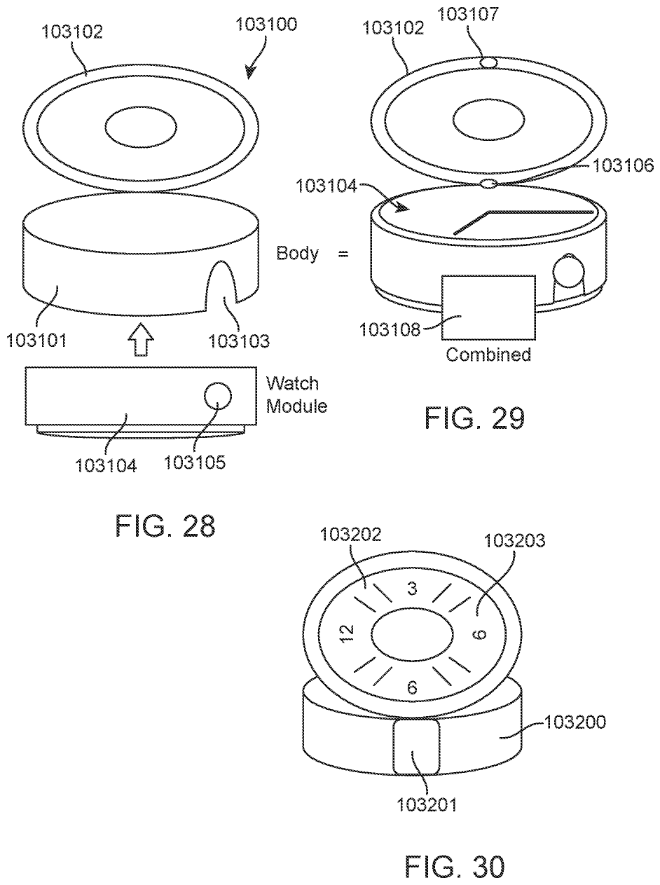

The smartwatch unit and the box may have any shape and may be integrated together by any means, methods, etc. According to one embodiment, the smartwatch module may be entered/integrated from the bottom of the housing into the housing. As an example, FIG. 28 shows a box 103100 having a housing 103101 and a cover 103102. Said box is preferably designed to accommodate (e.g. the components of) a smartwatch (e.g. a unit/module) 103104 from the bottom of the housing. Note that in this example, the housing has a hole in the bottom to accommodate the smartwatch from the bottom. The housing also may have a hole 103103 in its side wall to accommodate the side button 103105 of the smartwatch module 103104. FIG. 29 shows the smartwatch module 103104 after being accommodated within the watch box/housing. In this example, the cover 103102 of the box is in open position and preferably therefore the/a virtual watch face (e.g. in enlarge state) occupies the entire/a large portion of the screen.

In the current example, a speaker (and/or a microphone) 103106 may be located in the luxury watch in a manner such that when the cover 103102 is on open position the (most of) the audio is directed to the user's face (e.g. ear). Also as shown, a (e.g. one or more) camera may be integrated inside 103107 and/or outside (not shown) of the cover 103102 to take photos.

According to one system, the inside face of the cover may also have a display unit (e.g. to show a photo being taken). In this example, the cover opens in the axis of the strap 103108. It must be noted that the cover may be opened or closed in any axis.

FIG. 30 shows an example of a simplified method/system to transform a regular smartwatch into a luxury item. In this example, the watch box has (e.g. only) a reduced/partial housing 103201 attached to the cover 103202 having the physical dial element 103203. Said reduced housing is used to accommodate an entire smartwatch or a smartwatch module 103200 such that only the front face of the smartwatch is covered by the cover 103202 and substantially all other portions (e.g. except the portion covered by the partial housing) of the surface/body of the smartwatch are not covered by the box. In this example, the smartwatch substantially keeps its original form factor but becomes covered by the cover of the housing when the cover is in closed position, giving the smartwatch an appearance of a luxury smartwatch.

### Planar Opening/Closing Cover

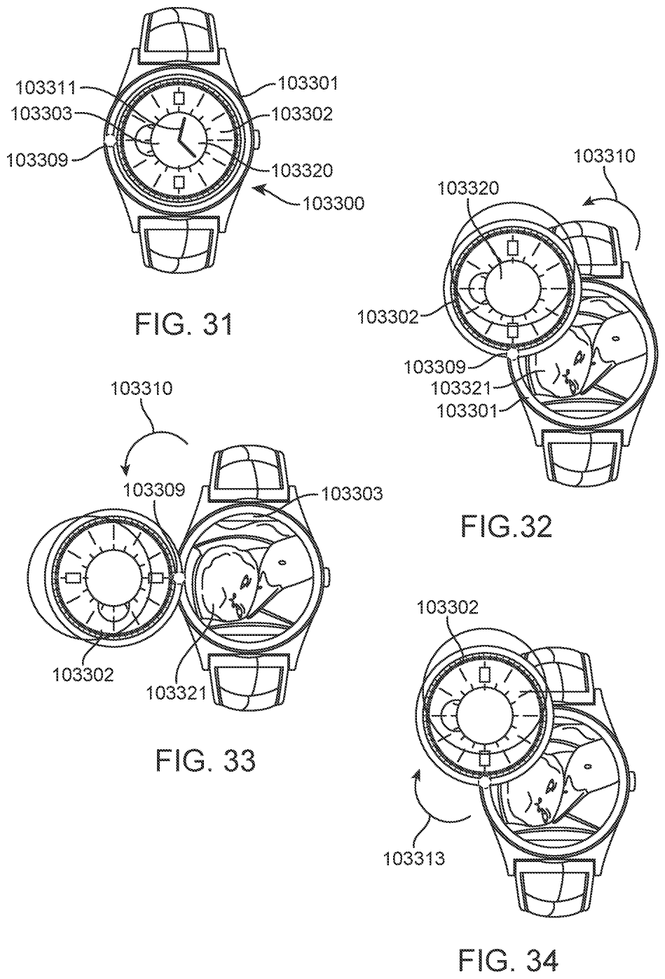

According to one aspect, the cover (e.g., having a window) of the housing of a smartwatch of the invention may be opened and/or closed by, preferably, a planar opening and/or closing movement as shown in exemplary FIGS. 31 to 34 and explained hereafter.

FIG. 31, shows a smartwatch 103000 of the invention having a cover 103302 and a housing 103301 (e.g., here, covered by the cover 103302). In this example, the cover 133002 is opened and/or closed by pivoting around a pin/hinge 103309 in a circular manner. In FIG. 31, the cover 103302 is in closed position, therefore, watch hands 103311 are displayed on the screen 103303 in accordance with the window 103320 of the cover. Said watch hands 103311 are also displayed in accordance with the signs on the cover regressing hours, as described throughout this patent application.

In FIG. 32, the cover 103302 is in partially open position. As mentioned before, the cover is opened in a circular manner 103310 by pivoting (e.g., by a user) the cover around a pin 103309. In this example, because the cover is (e.g. partially) opened, the smartwatch may display a content (e.g., other than watch hands) 103321 anywhere on the screen 103003 regardless of the position/location of the window 103320 within the cover 103302. In FIG. 33, the cover 103302 is opened is completely opened in a circular manner 103310 by pivoting the cover around the pin 103309. In FIG. 34, the cover 103302 is partially closed position after the cover being pivoted in opposite circular direction 103313. The user may pivot the cover in said opposite direction until the cover becomes completely closed. In this case, preferably, (e.g., after a predefined lapse of time) a (e.g., the) smartwatch system may display watch hands (e.g., as described herein) on the screen.

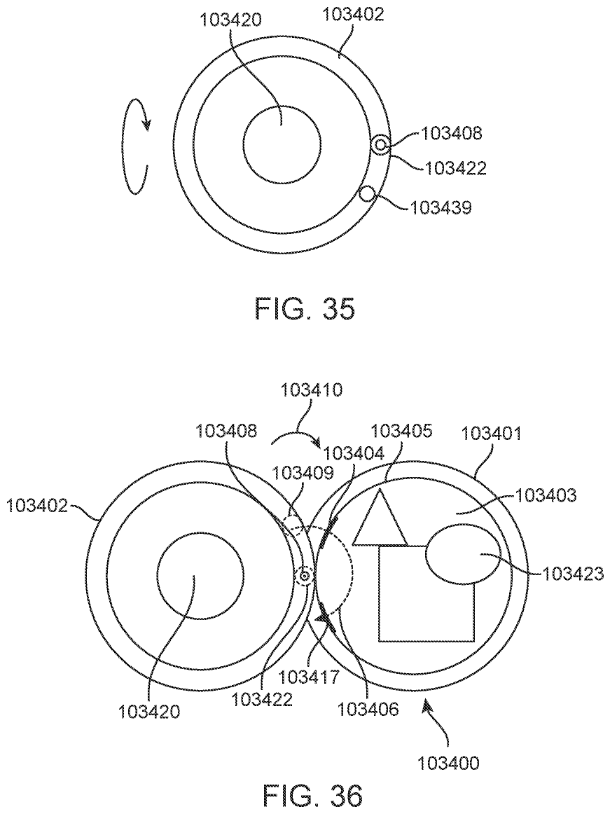

As mentioned before, the smartwatch may use any type of alerting means/method/system for informing the smartwatch system that the cover is in open position or in closed position. According to one embodiment of the invention (e.g., by considering the planar opening/closing system of the cover as described before), an alerting system/means may be used for informing the smartwatch system that the cover is in open position or in closed position. As an example, FIGS. 35 to 39, show an example of such a system. FIG. 35 shows the interior view of a cover 104002 of a smartwatch of the invention having a window 103420. A node 103409 (e.g., made of materials (such as defined before) to which the touchscreen reacts when the node interacts with it,) is integrated/implemented, preferably, on or closed to an edge of the cover 103402. Said cover is designed to circularly pivot around a hinge/pin 103408 so that to cover and/or uncover the housing of the smartwatch. The pin may be part of a more complex opening/closing system 103422. FIG. 36, shows (e.g. the exterior side of) said cover 103402 attached to the housing 103401 of a corresponding smartwatch device 133400. In this example, the node 103409 and the opening/closing system 103422 are shown by discontinued lines because, preferably, they are not visible on the exterior side of the cover 103402. Also, the hinge/pin 103408 may not be visible on the exterior side of the cover. In this example, the (cover of) the smartwatch 103400 is in entirely open position (e.g. the cover 103402 has rotated approximately 180 degrees relating to the housing 103401 in a circular planar manner) and (e.g. accordingly, as a result, etc.) the smartwatch displays a first content. 103423 (e.g., substantially occupying the entire surface of the screen) regardless of the location of the window 103420 within the cover 103402.

With continuous description of the current embodiment, in this example, the cover 103402 is designed to rotate around a hinge/pin 103408 in a circular planar manner 103410. The rotation can be in the circular direction of the hands of a watch (e.g., for closing the housing by covering the housing by the cover) and/or in an opposite circular direction (e.g., for opening the housing by removing the cover). Or vise versa. As such, when a user starts to close the cover 103402, the node 103409 starts to circulate in a predefined trajectory 103406.

According to the current embodiment, a specific application/software (e.g., the operating system of the smartwatch, a predefined application other than the operating system of the smartwatch, a third-party application, etc. Herein may be referred to as “specific application”) running in the background (e.g., preferably, regardless and/or independently of any other application running on the main portion of the smartwatch screen) displays (e.g., at least most of the time (e.g., preferably, always) a virtual window (e.g., preferably in form of a (e.g., thin) bar (e.g., curved bar if the screen is round, straight bar if the screen is round)) 103404 on (e.g., and along) an edge 103405 of the touchscreen 103403 while said specific application is running so that when the node 103409 enters-into/touches the touchscreen, the node at first interacts with said virtual window (e.g., before interacting with the interface of any other application) on the touchscreen.

In this case, a corresponding event produced by said/the interaction (e.g., and captured by the operating system of the smartwatch) is captured-by/assigned/directed-to said specific application (e.g., or to another predefined application related to said specific application). In this case, said specific application (e.g. or said related application) controls (e.g., gets and processes information about) the movement (e.g. measurement of the trajectory) of the swiping interaction of the node 103409 (e.g., traveled) with/on the touchscreen 103403 (e.g., from the virtual window).

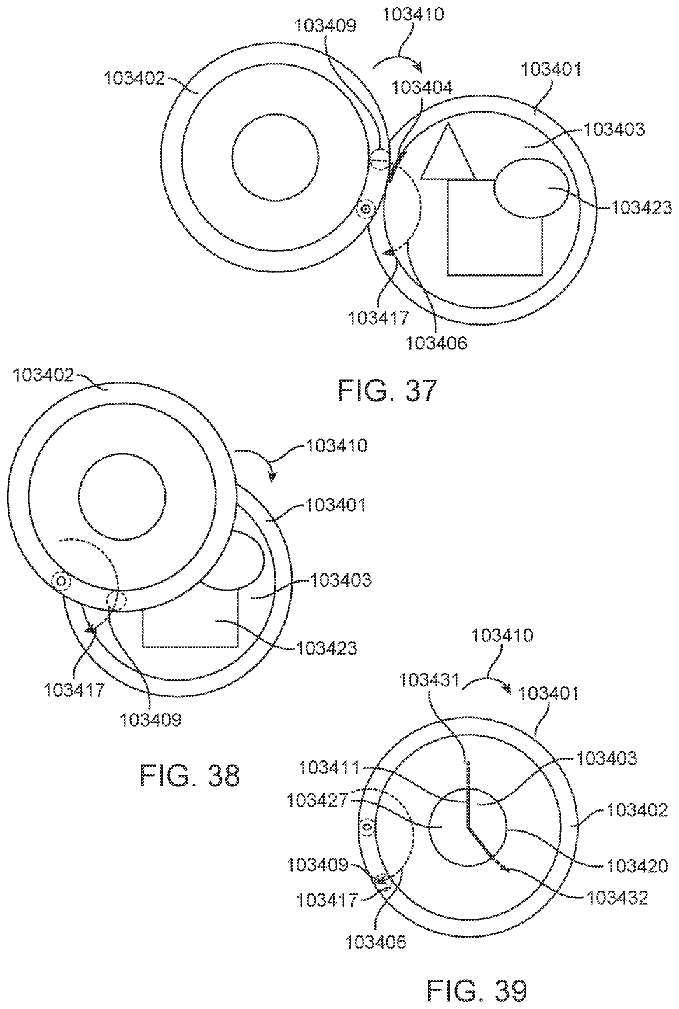

As shown in FIG. 37, when a user starts to close the cover 103402 (e.g., by rotating the cover in direction 103410), the node 103409, starts to approach the virtual window 103404 and touches it before touching the interface of any other application on the screen. Now, said specific application may preferably control (e.g., measure) the movement of the swiping interaction of the node 103409 in the/trajectory 103406 with/on the touchscreen 103403. As shown in FIG. 38, the user has continued to rotate the cover 103402 in the direction 103410 and the cover 103402 is now partially covering the housing 103401. In this case, the specific application or its/a related application controlling the movement trajectory of the node on the touchscreen 103403 (e.g., and/or the smartwatch operating system) knows//is-informed that the cover is not completely closed. In this case, preferably, the smartwatch system continues to display the/an interface/content 103423 of the/any main application which is running on the touchscreen.

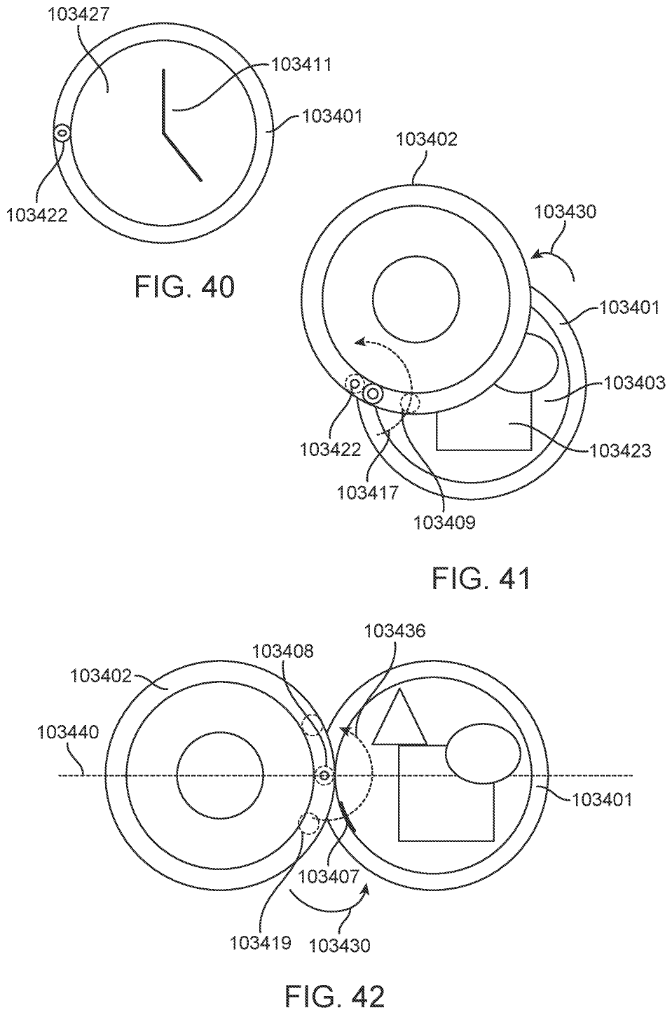

With continuous description of the current embodiment, as shown in FIG. 39, if the user continues to rotate the cover in the direction 103410, at a predefined/specific instance (e.g., in regard to the position of cover relative the housing), the specific application and/or its/a relating application (e.g., and/or the smartwatch operating system) understands/defines/is-informed that the cover is in a practically completely closed position (e.g., the node 103409 exits the touchscreen 103403 at the point/location 103417 of the touchscreen). In this case, a different/predefined (e.g., exemplary) content 103427 (e.g., replacing and/or overlaying the content 103423 of the/a main application displayed on the screen) including watch hands 103411, preferably showing a current time is displayed (e.g., by, at least one of, the smartwatch system, said specific application, a related application, etc.) on the touchscreen 103403 in accordance with the location of the window 103420 within the cover 103402. Note that, in this example, the watch hands are partially viewed through the window 103420. The rest of the watch hands are hidden under the cover and are shown/referred-to by discontinued white lines 103431 and 103432. In FIG. 40 the cover of smartwatch of FIG. 39 is removed to show the appearance of the (e.g., exemplary) content 103427 of FIG. 39. In this example, the content 103427 is in form of a black layer (e.g., displayed above/replacing the previous content 103423) occupying the entire screen (e.g., and includes only watch hands to save power), in accordance with the location of the window 103420 within/of the cover 103402 of the housing 103401.

With continuous description of the current embodiment, different methods may be used for defining that the cover becomes/is practically closed. According to a first method, the length of the swiping trajectory 103406 of the node on/with the touchscreen 103402 may define that the cover is closed. According to a second method, when the specific application or a related application detects that at the end of swiping trajectory the node 103409 is not in contact with the touchscreen 103403 (e.g., the node has exited the touchscreen (e.g., at a portion 103417 of the edge of the touchscreen (e.g., the node has been lifted from the screen (e.g., an ACTION_UP event is produced/captured)), the system defines/assumes that the cover is in-closed-position/closed. According to a third method, at some point (e.g., instance) during the swiping action, the node 103409 interacts with a specific virtual window (e.g. now shown) which is preferably located on (e.g., and/or along) another portion of edge (e.g., see edge 103417 as shown in FIG. 38) of the touchscreen 103403 on the expected trajectory 103406 of the node 103409 on the touchscreen 103403). At that time the system may preferably define/assume/understand/is—informed that the cover is in-closed-position/closed. Etc.

### Opening Procedure of the Cover

With continuous description of the current embodiment, after the cover is closed, if a user desires to open the cover, he may rotate the cover in a corresponding rotating direction (e.g., 103430). In this case, (by referring to FIG. 41), according to a first aspect, the node 103409 (e.g., swipingly) interacts with the (e.g., content 103427 on the) touchscreen 103403. In this case, the specific application (e.g., the operating system of the smartwatch) controlling (e.g., the content 103427 on the) the screen, is informed about said interaction and (e.g., by considering that before said interaction the cover was in closed position) understands that the cover is being opened.

Accordingly, said application controlling (e.g., the content 103427 on the) screen displays another content (e.g., the last content before the cover was closed (e.g., 103423), a homepage, etc.) on the screen, replacing the content (e.g., 103427) which had been displayed on the screen when the cover was closed.

### Opening Distance Defines the Image/Content

According to one embodiment of the invention, a predefined parameter may define whether a cover should be considered as being closed or opened by the specific application (e.g., the smartwatch operating system) controlling the virtual window. Said parameter may be a number within a threshold within which the cover may be considered (e.g., by the operating system) as being in open position, otherwise the cover will be considered as being closed. (e.g., or vise versa). According to a first aspect, said parameter may be the (e.g., interaction) position of the/a node (e.g., at an instance of time) on the touchscreen. For example, during the swiping interaction provided by a node with the touchscreen by rotating the cover, the smartwatch operating system may measure the (e.g., X, Y) position of the node on the screen. If said position is within a threshold, the system may consider that the cover is in open position, otherwise the system may consider that the cover is in closed position.

With continuous description of the current embodiment, according to a second aspect, said parameter may be the length of the trajectory of a swiping interaction provided by a node with the touchscreen. For example, during the swiping interaction provided by a node with the touchscreen by rotating the cover, the smartwatch operating system may measure the length of the trajectory of the swiping action provided by a node on the touchscreen. If said length is within a threshold, the system may consider that the cover is in open position, otherwise the system may consider that the cover is in closed position. Other aspects may be considered by people skilled in the art for the same purpose.

### Opposite direction of Watch Hands

As mentioned before, the planar rotation/circular direction of the cover may be in the direction of watch hands showing time 103410 and/or in the opposite direction of watch hands 103430. FIG. 42, shows the cover 103402 being rotatable in the opposite direction of watch hands 103430. In this case, as an example, a node 103419 (e.g., positioned within the cover) and the/its corresponding virtual window 103407 (e.g., positioned on the screen) may preferably be placed oppositely (relative to the horizontal axe 103440) to the position of the node 103409 (e.g., positioned within the cover) and its corresponding virtual window 103404 (e.g., positioned on the screen) (as described before and shown in the exemplary FIG. 37), in accordance with the principles described herein. In this example, the trajectory of the swiping 103436 interaction provided by the node 103419 with/on the touchscreen 103403 is in the opposite direction of the watch hands as shown by the discontinued-lined circular arrow 103436.

### Both Circular Directions, Direction of Rotation Defines the Node to be Consider

### May be Complete Circular Rotation

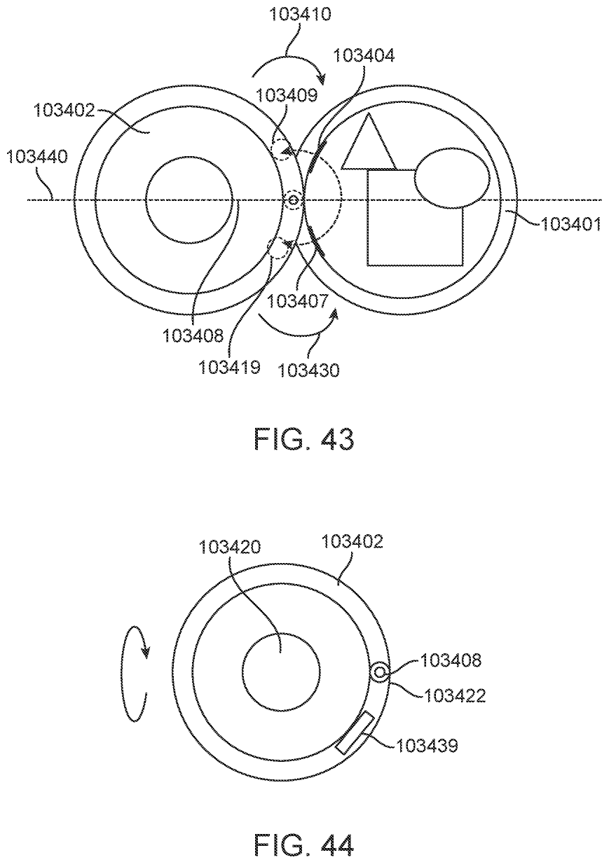

As mentioned before, the planar rotation/circular direction of the cover may be in the direction of watch hands showing time and/or in the opposite direction of watch hands. FIG. 43 shows, as an example, the cover 103402 being rotatable in, both, the direction of watch hands 103410 and the opposite direction of watch hands 103430. In this case, a first node 103409 (e.g., positioned within the cover) and its corresponding virtual window 10404 (e.g., positioned on the screen) are placed in a first location in relative to the pin/hinge 103408 in accordance with the principles described before. In this case, preferably, when the rotation direction of the cover is in the direction of watch hands of a watch 103410, the system preferably considers/defines the status of a cover (e.g., being in opened position, or being in closed position) based on the interaction of the node 103409 with the virtual window 103404.

With continuous description of the current embodiment, a second node 103419 (e.g., positioned within the cover) and the/its corresponding virtual window 103407 (e.g., positioned on the screen) are preferably placed oppositely (e.g. relative to the horizontal axe 103440) to the position of the node 103409 and its corresponding virtual watch hands 103404. In this case, preferably, when the rotation direction of the cover is in the opposite direction of watch hands of a watch 103430, the system preferably considers/defined the status of a cover (e.g., being in opened position, or being in closed position) based on the interaction of the node 103419 with the virtual window 103407.

Having two sets of node and virtual screen as just described, will permit to rotate the cover in, both, watch hands direction and opposite watch hands direction for closing the cover. As a result, in both cases the smartwatch system is informed that the cover is closed or opened.

The implementation of two sets of node and virtual window permits to rotate the cover in 360 degrees for opening and closing a cover.

### Size and Location of Virtual Window/S

Node and/or Virtual Window of any Size

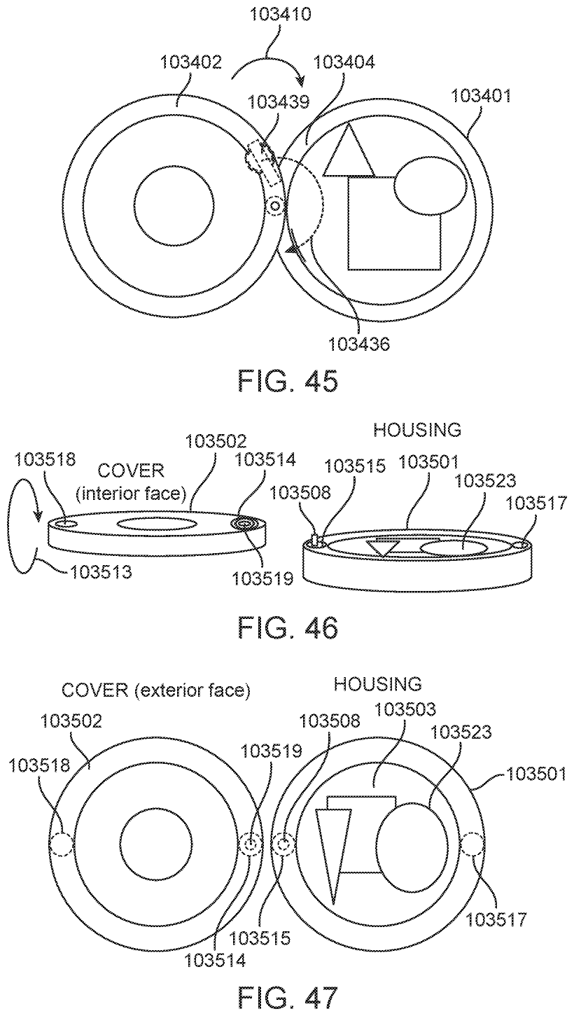

The node virtual and/or the virtual window may have any shape and/or aay size. According to one embodiment of the invention, the node may have a shape similar to the corresponding virtual window and be located on the cover in accordance to the location of the virtual window on the touchscreen. For example, the shape of node and/or the virtual window may be in form of a bar/line (e.g. a curved bar/line in case of a smartwatch with round screen, or a straight bar/line in case of a smartwatch with square screen, etc.). FIG. 44 shows, as an example, the interior side of the cover 103402 of FIG. 35 with the difference that, here, a bar-shape node 103439 replaces the round node 103409 of the cover of FIG. 35. FIG. 45 shows the exterior side of the cover 103402 of FIG. 44. As shown, the advantage of both the node 103439 and the virtual window 103404 of being large (e.g., in form of a bar) is that the contact surface between the node 103439 and the virtual window 103404 is larger than a contact surface between a small round-shape node and the corresponding virtual window. In this case, the event corresponding to interaction between the node and the virtual window may be more accurately/easier captured by the smartwatch (e.g. operating) system. Note that the width/thickness of the virtual window may be of a few pixels (e.g. less than 20 pixels, less than 10 pixels, less than 5 pixels, etc.) so that to occupy a non-significant portion of the screen.

### Virtual window all around the screen

According to one aspect, the virtual window may be in form of a circle occupying substantially the entire edge of the screen.

The/a node and the corresponding virtual window may be implemented anywhere within, respectfully, the cover and the housing. Preferably, the node and the corresponding virtual window are implemented near/adjacent to the rotating system (e.g., pin/hinge) so that to 14 reduce/eliminate an unintentional interaction (e.g., by the finger of a user) with said location/zone (e.g., 103405) of/on the screen (e.g., an unintentional/inadvertent swiping action provided from outside of the touchscreen interacting with the virtual window).

### Physical Sensor on the Edge of Bezel or Screen

Note that any other type of sensor may be used to sense/react to interaction with the node, replacing the virtual window. According to one embodiment, a sensing mechanism/system may be implemented within at least a portion of the edge of the front surface of the housing. According to another embodiment, a sensing mechanism/system, regardless of the touchscreen, may be implemented outside-and-adjacent to at least a portion of the edge of the touchscreen.

With regard to the current embodiment, when the node is in contact with said sensing mechanism, the system knows assumes/defines that the cover is closed, and when the node is not in contact with said sensing mechanism, the system knows assumes/defines that the cover is opened.

### Specific Zone/Location of the Touchscreen

When Closed from Interaction w Specific Location/Zone Defines Opening
When Opened Interaction w said Specific Location Defines Closing

According to another embodiment, no physical sensor is used for the same purpose. As an aspect of the invention, if the cover is closed position, an interaction of a node with a specific location/zone on the touchscreen, may be considered by the/a specific/predefined application (e.g., the operating system of the smartwatch) as the cover is being opened. On the other hand, if the cover is open position, an interaction of a node with said specific location/zone on the touchscreen, may be considered by the/a specific/predefined application (e.g., the operating system of the smartwatch) as the cover is being closed. Said specific location/zone on the touchscreen may preferably be a location/zone close/adjacent to the hinge so that to reduce/eliminate an unintentional interaction (e.g., by the finger of a user) with said location/zone (e.g., 103405) of/on the screen (e.g., an unintentional/inadvertent swiping action provided from outside of the touchscreen interacting with said location/zone).

### Opening/Closing System

The smartwatch may have an opening/closing system that simplifies user's interaction with the smartwatch when opening and/or closing the cover. According to one embodiment, magnets may be integrated within the housing and the cover of the smartwatch for such purpose. FIG. 46, shows a side view of the (e.g. interior side of a) cover 103502 of a smartwatch, and the housing 103501 of said smartwatch having a screen displaying a first content 103523 based on principles described throughout this patent application. In this example, the housing 103501 and the cover 103502 are shown separately. The cover 103502 is turned (e.g., rotated) 180 degrees 103513 to show the view its interior face. A first magnet 103515 may be integrated within the housing preferably at a location dedicated to implementing the pin/hinge for rotating the opening/closing cover 103502. A/the pin 103508 may be integrated/implemented (e.g., partially) within (e.g., a hole in) the magnet) said magnet 103515. A second magnet 103514 may be integrated within the cover 103502 at a location corresponding to the location of the first magnet 103515 integrated within the housing 103501. Said second magnet 103514 may preferably have a hole 103519 in accordance to the size (e.g. thickness, length) of the pin for accommodating a (e.g., remaining) portion of the pin for the rotating purpose. Said first and second magnets are integrated in a manner to attract each other and stick together (e.g., magnets have a North and South pole, and when one magnet's North pole is near another's South pole (e.g., or vice versa), they're attracted to each other and stick together.). Note that, according to one method the pin may be integrated within the magnet 103514 and the hole may be located within the magnet 103515, or vise versa).

With continuous description of the current embodiment, a third magnet 103517 may be integrated within the housing 103501, preferably, at a location opposite to the location dedicated to implementing the pin/hinge for rotating the opening/closing cover 103502, and a fourth magnet 103518 may be integrated within the cover 103502 at a location corresponding to the location of the third magnet integrated within the housing 103501. Said third and fourth magnets are integrated in a manner to attract each other and stick together.

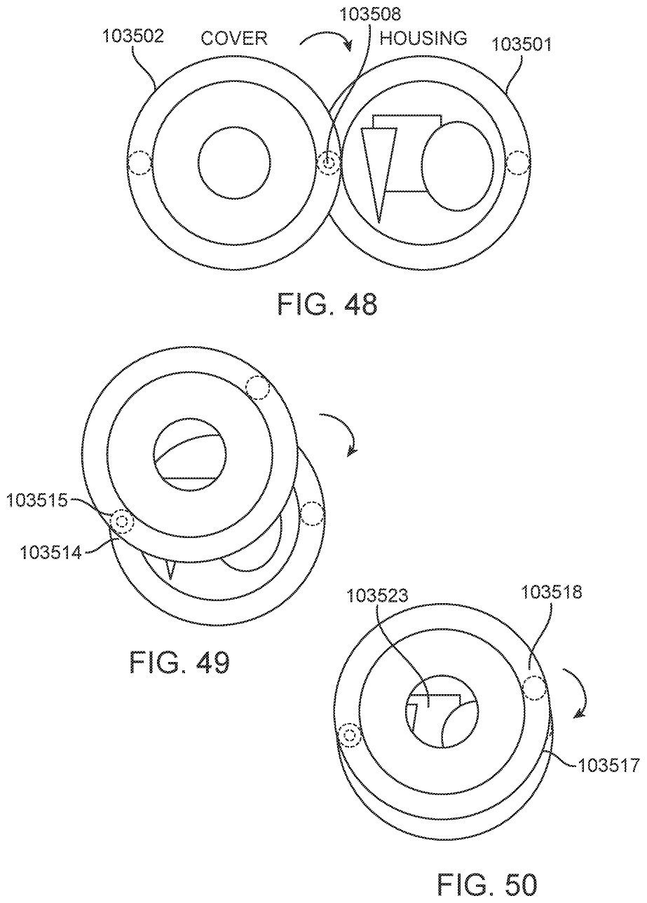

FIG. 47, shows the front view of said housing 103501 and the front view of the exterior face/side of said cover 103502 of the smartwatch of FIG. 46, disposed separately from each other. In this example, the second and fourth magnets integrated within the cover are shown by discontinued lines because, preferably, they are not visible on the exterior side of the cover. FIG. 48, shows the front view of said housing 103501 and said cover 103502 of the smartwatch of FIG. 47, rotatably (e.g., by the pin 103508) attached to each other (e.g., by the corresponding magnets 103514 and 103515).

As shown in FIG. 49, a user can practically easily rotate the cover over the housing in a planar circular direction (e.g., for opening and/or closing the cover) because the force provided on the cover for rotating it is perpendicular to the attracting forces provided by the magnets 103514 (e.g., hidden by the cover 103502) and 103515 towards each other.

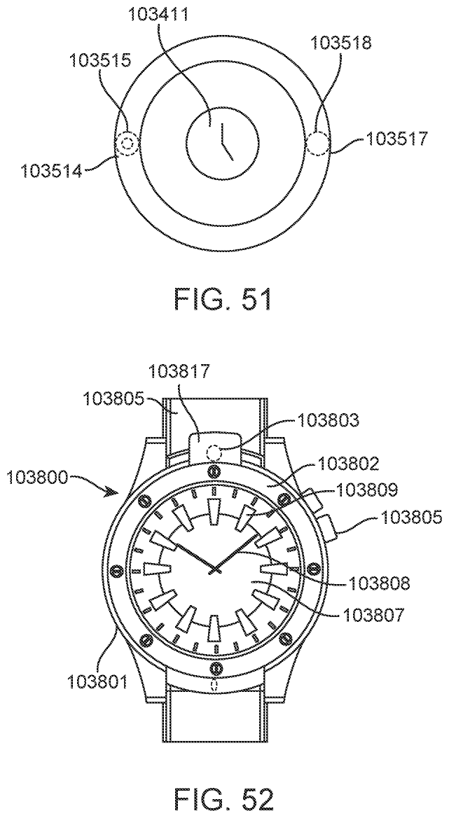

With continuous description of the current embodiment, if the user continues to rotate the cover 103502 in order to close it (i.e., in order to cover the housing 103501 by the cover 103502), at some point/instance such as that shown in FIG. 50, the magnets 103517 and 103518 may become very closed to each other. At this time, the magnets 103517 and 103518 (e.g., may) attract each other and stick together, closing the cover automatically (e.g., without the need of user doing so). In FIG. 51, the cover is closed and smartwatch system displays watch hands 103411 instead of the content 103523, in accordance to the principles described throughout this patent application. Note that the magnets may have any shape and/or size.

The opening/closing system may be implemented anywhere within or outside the body (e.g., housing and/or cover) of the smartwatch. FIG. 52, show a smartwatch device 103800 having a cover 103802 (e.g., in closed position) and a housing 103801 (e.g., hidden by the cover). In this example, an opening/closing system 103817 (e.g., including a pin 103803) is positioned in the axis of the smartwatch's bracelet 105805. Preferably, the opening/closing system 103817 extends at least partially outside of the body (e.g., housing and/or the cover) of the smartwatch to permit integrating a thick pin (e.g., having at least 4 millimeters of diameter) and still having a smartwatch with ascetically decent appearance.

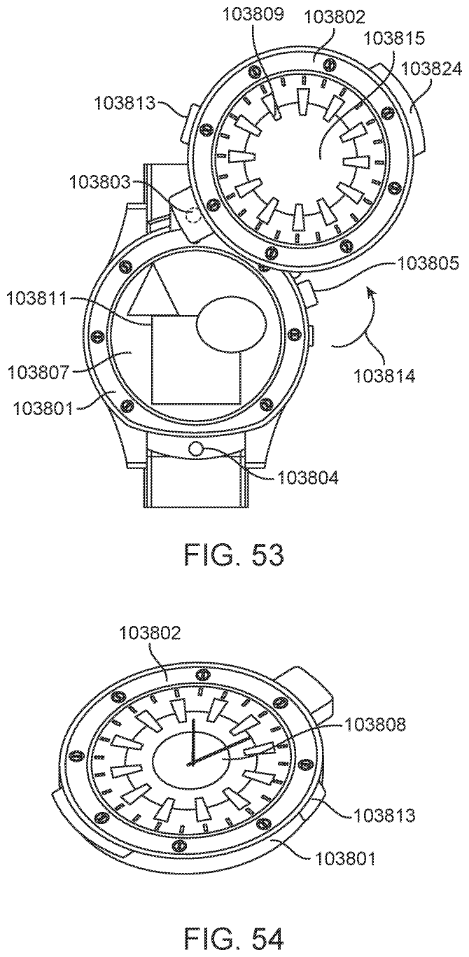

FIG. 53 shows the smarwatch's cover 103802 in open position. (e.g., opened in a planar manner 103814). An advantage of having the opening/closing system (e.g., with the pin 103803) implemented (e.g. at least partially) outside of the body of the smartwatch is in that the entire screen (e.g., display unit) 103807 of the smartwatch 103800 can be viewed without the need of rotating/opening (e.g., in planar manner) the cover 180 degrees. In this example, rotating/opening the cover 103802 approximately 110 degrees is enough to view the entire surface of the screen (e.g., display unit) 103807.

According to one embodiment, an alerting means may be used to inform a software running within the smartwatch (e.g., an operating system of the smartwatch) that the cover is in open position and/or in closed position.

According to one embodiment of the invention, the/an smartwatch device may have a programmable (e.g., side) button. When said button is not in pressed position (e.g., for at least a predefined lapse of time), said software (e.g., which is informed accordingly) may preferably consider/assume that the cover is in opened position. Accordingly, when said button is pressed (e.g., for at least a predefined lapse of time), said software (e.g., which is informed accordingly) may preferably consider/assume that the cover is in closed position.

By considering the above, as shown in FIGS. 53 and 54, the smartwatch device may preferably have a programmable button 103805 as described above. The cover 103802 of the smartwatch may have/include an element/portion 103813 integrated-within/attached-to said cover such that when the cover is closed (e.g. is in closed position), said element/portion 103813 presses the button 103805 (e.g., and keeps the button in pressed position as long as the element 103813 continues to press the button 103805), and said software is informed accordingly.

According to one aspect of the invention, as shown in FIG. 53, when the cover is in open position, the button 103805 is released (e.g., by the element 803813) and said software is informed accordingly. In this case, according to one aspect, an (e.g., any) output content (e.g., an output content (e.g., 103811) of a focused application running within the smartwatch device) of the smartwatch is displayed on the screen, preferably, regardless of the location of the window 103815 on-the-screen/within-the-cover.

Accordingly, as shown in FIG. 54, when the cover 103802 is in closed position (e.g., covering the housing 103801), the button 103805 is pressed by the element 103813 and said software is informed accordingly. In this case, according to one aspect, an (e.g., any) output content of the smartwatch is displayed on the screen in regard-to/by-considering the location of the window 103815 on-the-screen/within-the-cover. According to a preferred aspect, when said button 103805 is pressed (e.g., for at least a predefined lapse of time), a virtual watch hands 103808 (e.g., showing a current time) are displayed on the screen in accordance with the location of the window (e.g., on the screen or within the cover), as described throughout this patent application. Note that the opening/closing system may use magnets as described before. In the current example, magnets (e.g., 103804 and 103824 (hidden) implemented, respectively, within the housing and the cover) are used to stick together when the cover is practically closed, as described before.

The window of the cover may have any size and/or any shape. As shown in FIGS. 52 to 54, a physical dial implemented/designed in a cover 103802 is designed in a manner to permit implementing a large window 103815 within the cover 103802 so that to implement a viewable long/large virtual watch hands 103809 (e.g., when the cover is closed), while permitting to have a dial having a large-sized appearance as well. This is because the dial may be designed to have an openwork design. In the current example, the signs (e.g., on the cover) representing hours 103809 are arranged in an openwork manner enlarging the appearance of the dial and also permitting to have an apparently large window 103815 within the cover 103802.

### Detachably/Attachably Covers

### Interchanging Covers

The fact that the cover and the housing are attached to each other by magnets permits to detach the cover and the housing by using certain (e.g., significant) amount of force. As such, for a single smartwatch accommodated within a housing, a plurality of corresponding covers each having a different appearance (e.g., dial/watch face) may be used. A user may be able to detach the first cover from the housing and replace it with a second housing, and so on.

As mentioned before, the cover of the watch box may have more than one hole/window. As an example in addition to a first hole dedicated to a (e.g. one or more) first content, at least one other hole of the cover may be dedicated to displaying re-directing a (e.g. one or more) second content (e.g. such as date, chronometer, etc.) on the portion of the display corresponding to said at least one other hole of the display unit of the smartwatch.

Note that the term “(re-) directing” used in this application generally means to print a content relating to an application, function, etc., in a first form factor (e.g. small, partial, different) in a zone/portion of the display unit of the smartwatch that can be/is viewed through the corresponding hole of the cover (e.g. when the cover is closed position) to a user. As mentioned herein, said content relating to an application, function, etc., may be displayed in a second form factor (e.g. differently such as large, non-partial, different than said first form factor, etc.) when the cover is in open position.

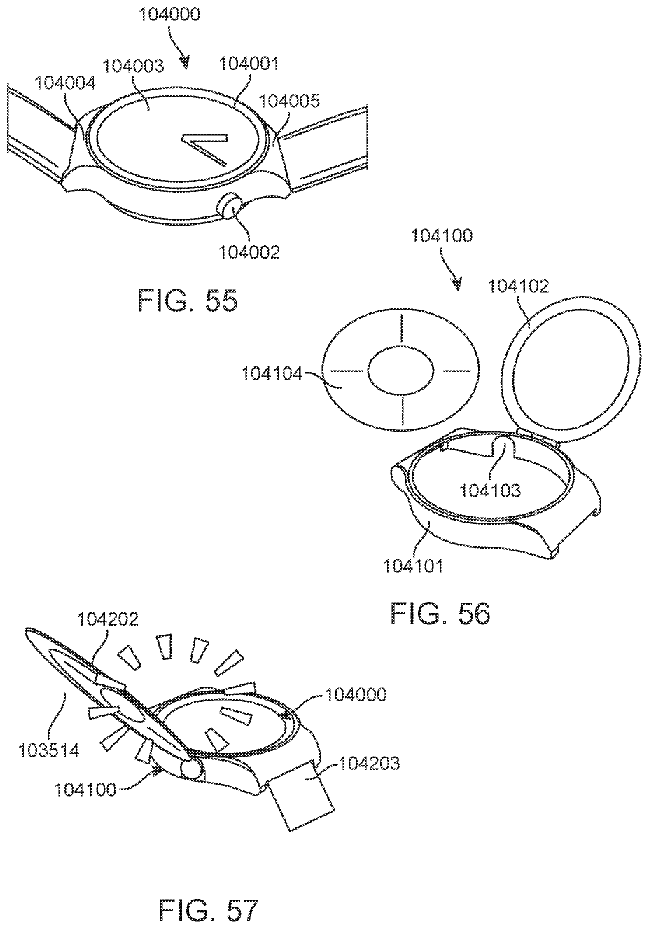

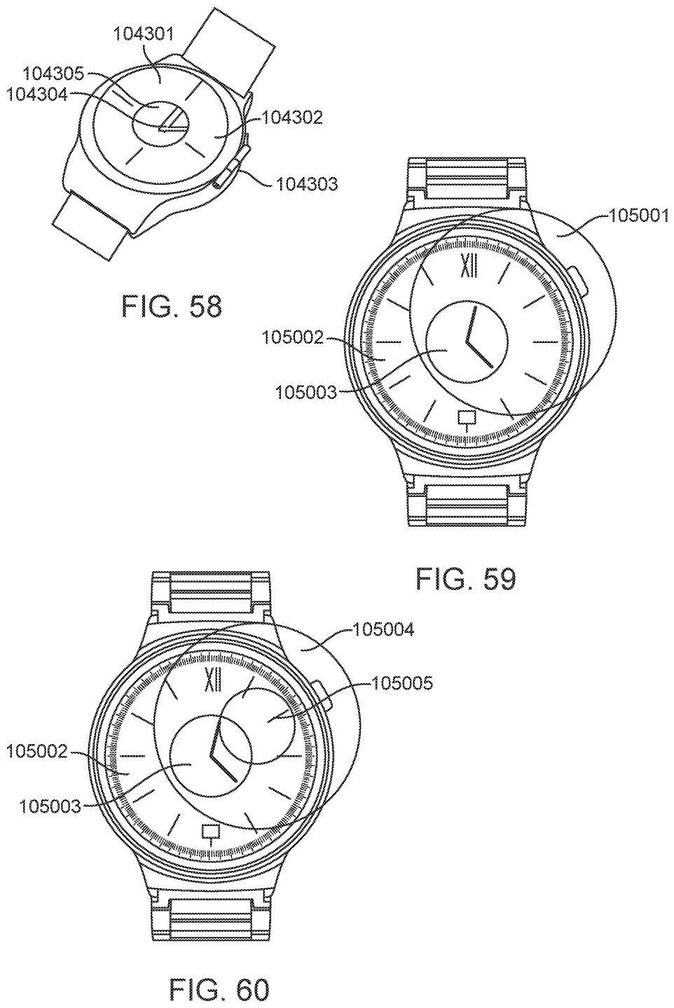

According to one embodiment, an/the entire smartwatch (e.g. including its horns) may be considered as a smartwatch module/unit and be integrated within a box. As an example, FIG. 55 shows an entire smartwatch 104000 having a housing 104001 that includes at least most of the components of the smartwatch mechanism/hardware and software, a button 104002, a screen 104003 and two horns 104004 and 104005 having attachment means to attach said smartwatch to the corresponding strap/s. FIG. 56, shows a box 104100 made to cover the entire smartwatch 104000. In this example, the box has a housing 104101 to accommodate the entire smartwatch including the horns of the smartwatch. In this example, the wall of the housing has a hole 104103 to accommodate the side button 104002 of the smartwatch. Preferably, the strap uses the smartwatch attachment points/means to attached to the smartwatch. Alternatively, the box/housing includes attachment points/means to attach to the strap. The box has a cover 104102 that preferably has/may-accommodate a watch dial/disc 104104. FIG. 57 shows the smartwatch 104000 being accommodated within the box (e.g. housing) 104100. In this example, the box cover 104202 is in open position. In this example, the strap 104203 remains attached to the smartwatch body. FIG. 58 shows the cover 104301 of the box in closed position by using the hinge 104303. When the cover is in closed position, preferably the watch hands 14304 become small and locate on the portion of the display unit corresponding to the hole 104305 of the dial 104302.

By using the above-mentioned principles, any/most of the regular/current smartwatches may be transformed to luxury smartwatches without interfering with the smartwatch manufacturers.

Note that at least a portion of the cover of the box may be covered by a (e.g. transparent) glass. For example, the portion of the cover that has a (e.g. one or more) hole may not be covered by a glass and the rest of the cover may be covered by a glass. Alternatively, the entire cover (e.g. including the hole/s) may be covered by a glass. As shown in FIG. 59 a glass 105001 may be used to cover substantially the entire surface of the cover 105002 including the hole 105003 in/of the cover, while as shown in FIG. 60 a glass 105004 having a hole 105005 corresponding to the hole 105003 of the cover 105002 may be used to (e.g. partially) cover the surface of the cover 105002 (e.g. excluding the (e.g. surface of the) hole 105003 of the cover).

Optionally said glass may be a touch screen. Said touch screen may be controlled by or be related to the processor of the smartwatch. According to one aspect, the cover may have its own touch screen/display.

One of the advantages of covering/using a regular/available smartwatch is that the provider/manufacturer of the box does not have to supply after-sale support for the smartwatch because such support may be supplied by the manufacturer of the smartwatch.

The hinge used to open or close the cover may be located anywhere. According to one embodiment, the cover may start from a hinge of the strap of the watch box and use said hinge to open or close the cover.

Note that the components of the smartwatch may not form a module. In this case, said components may be integrated separately and preferably connectedly (e.g. together) in the housing and/or in the cover of the box.

Note that to simplify the drawings, in some of the drawings the hinges attaching the cover and the housing are not shown but are preferably considered to exist in those drawings.

According to one embodiment, the smartwatch may have an alerting means to inform the user about an event. Said event may be of any kind such as an incoming call, a reminder, etc. Said alerting means may be of any kind such as a vibrator, a sound, an image, a mechanical means installed in the watch box and/or in the smartwatch touching (e.g. repeatedly) the user's skin, etc.

According to one embodiment, a (e.g. preferably rechargeable battery) power source may supply power only/mainly to (e.g. calculate and/or) display a time content output (e.g. preferably by displaying a watch hands (only) or optionally by displaying a watch face). Said (battery) power source may herein be referred to as the watch battery. Preferably, said time content output (e.g. watch hands) has a small form factor (e.g. shape and/or size) adapted to a predefined hole and is printed on a corresponding location of the smartwatch surface. Preferably, said time content output is displayed when the cover is in closed position. By displaying (e.g. only) a reduced size watch face/hands preferably (e.g. only) when the cover is in closed position, said watch battery may last long time (e.g. upon a single charge). The watch battery may preferably be separate from the power source of the smartwatch (e.g. herein may be referred to as the main battery) which supplies power for smartwatch functionalities (e.g. processing, displaying contents including time, etc.). By considering that a smartwatch's most popular function is showing time, most of the time, when the main battery is empty or turned off, the luxury smartwatch will/may continue to show time, working as a/similar to a regular (wrist) watch. Preferably, the watch battery is integrated within the smartwatch module. Optionally the watch battery is integrated anywhere else such as in the watch box or in the strap.

According to one embodiment, one side of the cover of the box of the smartwatch may have a display unit connected to the smartwatch to display the/a content of the smartwatch. The other side of the cover of the smartwatch may include a regular (e.g. physical) watch. Said cover may be rotatable relating to the housing of the smartwatch so that the use can rotate the face of the luxury smartwatch from displaying time to displaying smartwatch output or vise versa.

According to one embodiment, the front side of a luxury smartwatch may have a/the display unit of the smartwatch and the backside of said luxury smartwatch may show time (e.g. be covered by a regular wristwatch). In this case, according to one aspect, the luxury smartwatch may entirely be rotated on the wrist to show time or alternatively to show the output content of the smartwatch.

Preferably, the watch battery may be a component of a time system/unit that supplies power to provide contents relating to time such as the current time, chronometer functions, etc. Optionally, said time system/unit may use some of the components of the smartwatch system/unit such as the processor and the main display (e.g. to for example, respectively calculate and display time). Optionally, said time system may not use any of the components of the smartwatch system/unit, and may have its own components such as a processor and/or a display unit to, for example, respectively calculate and display time.

According to one aspect, the smartwatch device may have more than one display units. Preferably each of said more than one display units may be dedicated to display a different (e.g. type of) content.

According to one embodiment, the smartwatch device may have two display units, a first display unit that its printed content preferably substantially cover the entire surface of the screen/face of the smartwatch (e.g. herein may be referred to as the main display unit), and a second display unit that its printed content specifications (e.g. size and/or location, etc.) may preferably corresponds to a (predefined) hole within the cover of the smartwatch box (e.g. such display may herein be referred to as the secondary display unit).

Preferably, said main and secondary display units function independently from each other.

Preferably, each of said main and secondary display units may be dedicated to display a different (e.g. type of) content. As an example, the secondary display unit may mainly be related to the time system and the main display unit may preferably/mainly be dedicated to display any output content of the smartwatch.

The type of said display units may be similar or they may be different in type. As an example both displays units may be OLED displays. According to another example, the main display unit may be an OLED display and the secondary display unit may be a LCD display.

Said main and secondary display units may have the same size or they may be different in size. Said display units may be integrated together such that to form a single (e.g. multi-layer (e.g. 2-6 layer)) display unit, or they may be independently/separately from each other be integrated within the smartwatch device.

According to one method, said main and secondary display units may be integrated within the smartwatch such that to supersede each other. Preferably at least one of said main and secondary display units (e.g. preferably, the display unit which supersedes the other display unit) may have a degree of transparency or be transparent so that to permit the light to pass through it (e.g. traverse it).

Preferably, when one of said main and secondary display units is displaying its content, the other display unit does not display any content. Alternatively, both displays simultaneously display their respective contents.

Preferably, the content related to the secondary display unit is displayed on said secondary display unit when the cover of the smartwatch screen/box is in closed position, or when the battery power source of the smartwatch unit is empty, or when the smartwatch unit is turned off, or when the main display unit is turned off (e.g. for at least a predefined lapse of time), etc.

According to one aspect, when the cover is in closed position, an output content (e.g. a notification) of the smartwatch unit is displayed, for a predefined lapse of time, on a portion of the main display unit that corresponds to a (e.g. predefined) hole within the cover. Accordingly, preferably, while said content of the smartwatch unit is displayed on said portion of the main display unit, the output content of the secondary display unit is removed (e.g. not displayed) (and vise versa).

With continuous description of the above descriptions, two scenarios of superseding display units may be considered:

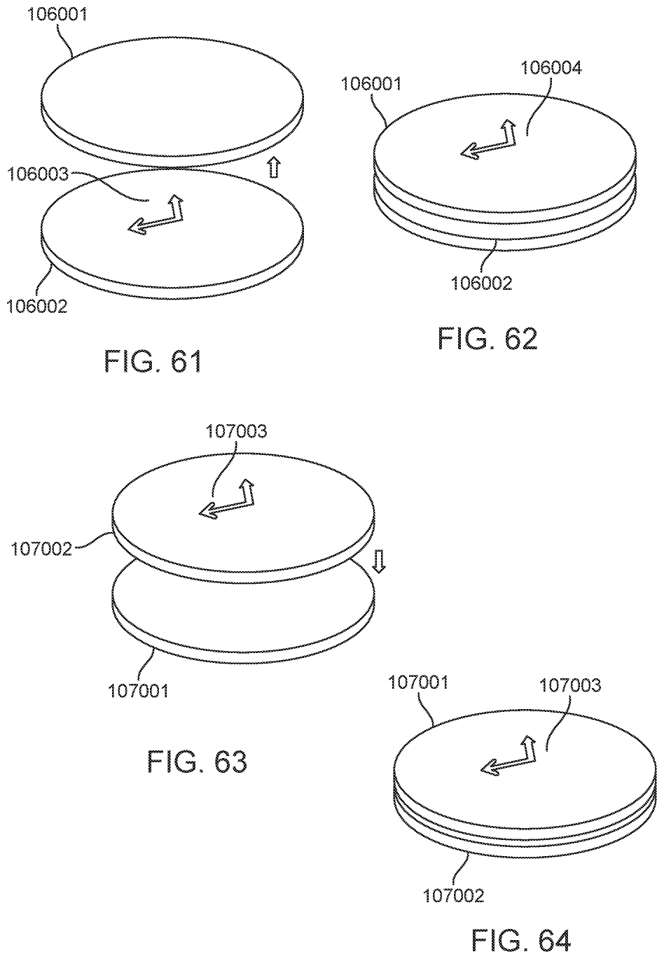

Scenario 1: (preferred) The main display unit supersedes the secondary display unit. FIG. 61 shows as an example, the main display unit 106001 of the smartwatch unit (e.g. of the invention) dedicated to display the output content of the smartwatch unit. Said main display unit preferably occupies substantially the entire surface of the screen/face of the smartwatch unit. Preferably, said main display unit has some degree of transparency or is transparent. The smartwatch device (not shown) has also a secondary display unit 106002 which in this example is dedicated to display contents related to the time system (e.g. in this example, it displays dynamic watch hands 106003 according to the current time). In the example of FIG. 62, said main and secondary display units are integrated within the corresponding smartwatch box (not shown) such that the main display unit 106001 supersedes the secondary display unit 196002. In this example, the main display unit is transparent. Accordingly, the light of the content displayed on the secondary display unit (e.g. watch hands) traverses through the main display unit and said content (watch hands) 106004 may be viewed to a person looking at the screen of the smartwatch device.

Scenario 2: The secondary display unit supersedes the main display unit. FIG. 63 shows as an example, the secondary display 107002 superseding the main display unit 107002. In this case, the secondary display unit is preferably transparent or has a degree of transparency so that to permit the content of the main display unit to become visible to the a user looking at the screen of the smartwatch device.

Note that, in accordance with the scenario 2, the content (e.g. 107003) displayed on the secondary display unit may be viewed brighter/sharper to a user looking at the screen of the smartwatch device compared to the same content (e.g. 106003) displayed on the secondary display in accordance with scenario 1.

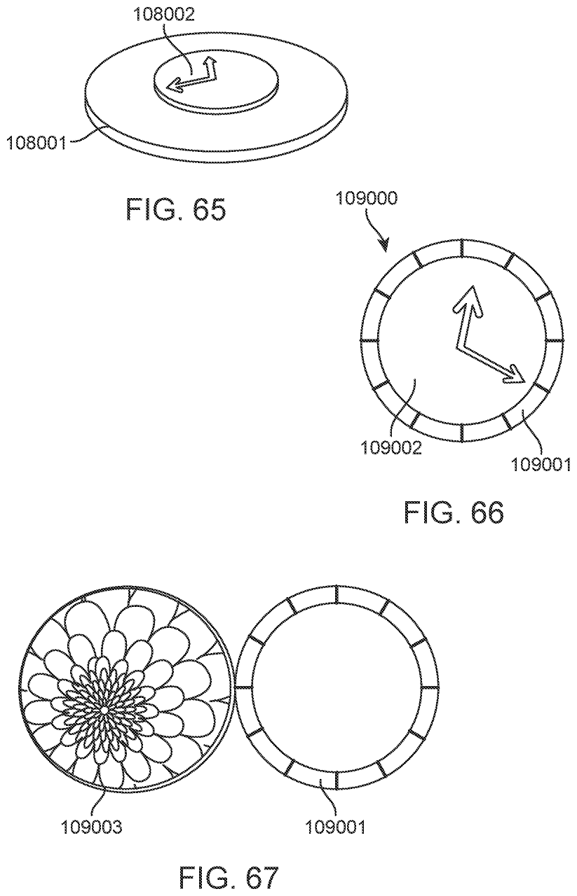

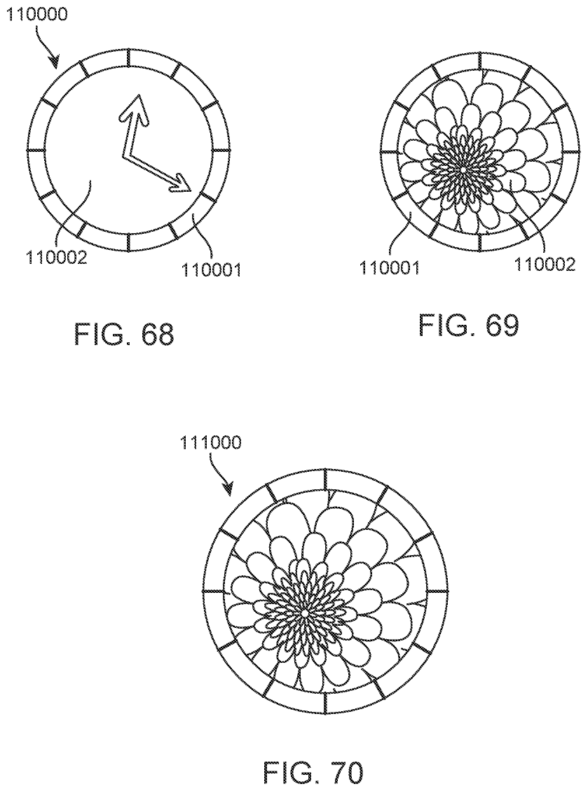

Other scenarios may also be considered. As an example, as shown in FIG. 65, a main display unit of the smartwatch system may be comprised of a first portion 108001 and a second portion accommodating the secondary display unit 108002, together forming the main display unit of the smartwatch. Accordingly, for example, when the cover is in closed position, the secondary display unit displays the time-related content, and wherein when the cover is in open position, the entire main display unit (e.g. said first display unit together with said secondary display unit) display contents related to the smartwatch system.

According to another scenario. the main display unit does not cover all of the secondary screen. Accordingly, the portion of the secondary screen which is not covered by the main screen is the same portion which is not covered by the smartwatch cover.

According to one embodiment, at least said secondary display unit (e.g. of the time system) is located within the cover of the smartwatch, preferably at the location of the hole within the cover (e.g. face to the outside of the box (e.g. face to the user) when the cover is closed position). In this case, when the cover is in closed position, said secondary display unit supersedes the main display unit and preferably shows a content related to time (e.g. shows the current time). In this case (e.g. the sensor (e.g. which is inside the box) does not detect (e.g. enough) light and the corresponding processor detects that the cover is in closed position, and), preferably, the main display unit is turned off (e.g. by the corresponding processor) to save power (e.g. of the main battery). Preferably, when the cover is in open position, said secondary display unit may be turned off to save power (e.g. of the secondary battery). The secondary display unit is preferably transparent. Accordingly, optionally, when the cover is closed position, a content (e.g. a notification) of the smartwatch system may be directed and/or displayed on a portion of the main display unit that corresponds to a/said hole within the cover. In this case, preferably, the content of the secondary display unit is (e.g. temporarily (e.g. for a predefined lapse of time) removed (e.g. the secondary display unit is turned off) so that to permit the user to see said content which is displayed on the main display unit.

Note that according to one aspect, one of the smartwatch and time systems (e.g. preferably the smartwatch system) includes the/said sensor (e.g. for detecting if the cover is in close position or open position) described herein. According to one aspect, each of the both systems includes a sensor described herein.

According to one aspect, the time system tasks are generally dedicated to calculate and display (e.g. one or more) content related to time (e.g. watch hands, current time in digits, time of a chronometer, etc.)

Preferably, the secondary display unit is related to a virtual and/or physical time mechanism/system that preferably has its own processor that works independently from the smartwatch processor. Optionally, a single processor is used for executing functions related to the smartwatch system and the time system.

Preferably the physical and/or virtual components of the smartwatch unit function independently from the physical and virtual components of the time unit. Optionally, smartwatch unit and the time unit have at least some common physical and/or virtual components.

Preferably, each of said main and secondary display units is controlled by a different processor that function independently from each other. Preferably, each of said main and secondary display units may preferably be supplied by a different battery power source that function independently from each other.

The principles described throughout this application permit to create a smartwatch device with a traditional wrist watch appearance that mainly shows (e.g. current) time when the cover when the cover is in closed position, and functioning as a regular smartwatch with a large display when the cover is in open position.

Creating a smartwatch having a cover including a window, wherein said cover having marks related to hours, and/or minutes, and/or seconds (e.g. as a (e.g. physical) watch dial), and wherein using the screen of the smartwatch for displaying watch hands when said cover is closed, and wherein the combination of the said (e.g. physical) watch dial and the virtual watch hands show time greatly enhances a smartwatch usage. FIGS. 66 to 67, shows the advantage of such smartwatch in comparison with a smartwatch that has not cover.

FIG. 66 shows an exemplary smartwatch 109000 having a cover 109001 used as a (e.g. physical) dial (e.g. when the cover is in closed position). The cover 109001 has a window so that a portion 109002 of the screen of the smartwatch is visible to a user. When the cover is in closed position, preferably (e.g. an application of/and application running within) the smartwatch displays virtual watch hands content which is (e.g. partially (e.g. if the hands are adapted to the size of the window) or entirely (e.g. if the size of the hands is larger than the size of the window) are displayed so that combination of said cover (e.g. physical dial) and virtual watch hands show time and resemble to a conventional/traditional (wrist) watch.

After opening the cover 109001 (e.g. in this example, by sliding it from above the housing/box/screen), as shown in FIG. 67, (e.g. substantially) the entire surface 109003 of the screen of the smartwatch may become available for displaying a (e.g. another) content of the smartwatch. In tis example, a picture is displayed on the entire surface of the screen 109003 of the smartwatch 109000 by an application.

For comparison purpose, an apparently similar smartwatch device 110000 is shown in 110A. In this example, smartwatch 110000 does not have a cover and its bezel 110001 is used as a physical dial. Although the faces of the smartwatch devices 109000 and 110000 have the same size, the size of the screen 110001 of the smartwatch 110000 that uses its bezel as the dial is significantly smaller than the size of the screen 109003 of the smartwatch 109000 that uses its cover as the dial. In this example, in order to have a screen with the size of the screen 109003, the total size of the face of the corresponding smartwatch including a bezel (with the same width as the bezel 110001 as shown in Fig, 68) will have the size of the face of the smartwatch 111000 of FIG. 70, which will be enormous (e.g. on a wrist) in comparison of the smartwatch 110000.

Note that in the example above, the dial is considered to be very narrow, otherwise, in case of FIG. 68, the size of the screen of the smartwatch 110000 would have been much smaller and even impractical for smartwatch functionalities, and in case of the smartwatch 111000 of FIG. 70, the size of the watch face would have been much larger making the smartwatch device impossible to carry on a wrist.

Note that the principles described in this patent application can be applied to any type of watch/device such as a pocket watch and a smartphone having a cover imitating a dial.

The cover of the smartwatch may be of any type of material such a metal or plastic. As an example, the cover may be made by using a kind of metal and the window may be made of a transparent material such as glass or plastic.

If the cover is made of materials that can be nontransparent and/or transparent such as plastic, glass or the like, the cover may be made of a single piece using a said material such that a portion of the cover relating to the dial may be nontransparent and the window may be transparent.

The principles described herein permit to create a smartwatch device with a traditional wrist watch appearance (e.g. having a physical watch dial (e.g. as the cover itself, or integrated within the cover) that can show time for a very long period (e.g. months) and wherein its smartwatch functionality can last as long as any other smartwatch generally do.

Note that in some embodiment, the sensor helping to detect if the cover is open position or in closed position has been described as the light/optical detector sensor. It is understood that any other type of sensor for helping to detect if the cover is open position or in closed position, such as optical, movement, heat detector, distance detector, pressure detector, etc, can be used for the same purpose.

It is understood that the embodiments in this patent application are exemplary. Based on the principles described herein, other methods/system of transforming a smartwatch into a luxury item may be considered by people skilled in the art.

Note that in this application, the terms “watch face”, “watch dial” and “watch hands” are used to explain some of the principles of the invention. In general/preferably, the term “watch face” may preferably be referred to a watch dial together with the watch hands, and the term “watch dial” may preferably be referred to a watch face (virtual or physical) excluding the watch hands or it may preferably be referred to a surface (virtual or physical) that shows/includes the digits or other signs (e.g. bars) that represent hours (e.g. 1 to 12).

Note that the any aspect, principle, mean, embodiment, function, system, method, features, etc., described in this application can be used/function separately or be combined-with/replacing any of the other principles, means, embodiments, functions, systems, methods, features, etc., described in this application. It must be noted that the word “screen”, used in many paragraphs of this patent application, preferably refers to a “touchscreen”. Also, note that the word “Integrated”, used in many paragraphs of this patent application, preferably refers to a “implemented”, and vise versa.

All of the, embodiments, features, systems, method, etc., described in this patent application may be used for devices/purpose other than a smartwatch. As an example, the opening/closing system of the invention using magnets and pin/hinge may be used for opening/closing any other device having two pieces wherein one of said two pieces closes and/or opens a surface of the other piece. As an example, the alerting system using a node and a (e.g., virtual) window may be used as an alerting means of any other device (e.g., having a housing and a cover). In this patent application, a specific application (e.g., and/or a corresponding application) controlling a virtual window has been described. Said specific application (e.g., and/or a corresponding application) may be any type of application/software such as an operating system (e.g., of the smartwatch), a software written and/or integrated/implemented by a manufacturer of a/the device (e.g., the smartwatch), a software written and/or integrated/implemented by a user of a/the device (e.g., the smartwatch), etc., (and/or a combination of said softwares).

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention.

1. A smartwatch device comprising:
a smartwatch unit having a screen;
a housing to accommodate at least a number of components of said smartwatch unit, wherein said housing has a cover to cover at least a portion of said screen and wherein said cover is openable and/or closable, and wherein said cover has a window so that when said cover is in closed position, the corresponding portion of the screen is visible to a user, and
wherein said cover includes a physical watch dial;
wherein said smartwatch unit has at least two display units wherein a first display unit is dedicated to display virtual watch hands when said cover is in closed position so that combination of said physical watch dial and said virtual watch hands show time, and
wherein smartwatch unit has a second display unit dedicated to display an output content of the smartwatch unit when the cover is in open position.

2. The device of clam 1, wherein said first and second display units function independently from each other.

3. The device of clam 1, wherein said first and second display units overlap each other.

4. A smartwatch device comprising:
a smartwatch mechanism having a plurality physical components including a screen and a processor, wherein said smartwatch mechanism further includes an operating system; and
a case having a housing and a cover;
wherein said housing accommodates at least some of the components of said smartwatch including said screen; and
wherein said cover is openable and/or closable such that when said cover is in closed position it covers said screen unit and wherein said cover has a window so that when said cover is in closed position, the corresponding portion of the screen is visible to a user, and
wherein said housing and/or smartwatch mechanism includes a button such that when said cover is in closed position, said button is pressed by said cover and wherein accordingly, the operating system of the smartwatch is informed by said processor that said button is pressed, and wherein after a predefined laps of time, said processor displays a virtual watch hands on at least a portion of the screen which is visible through said window wherein said virtual watch hands show (e.g., a current) time through said window.

5. The system of claim 4, wherein said cover includes a physical watch dial having signs related to hours, and wherein when said cover is in closed position, said virtual watch hands and said physical watch dial, together, show (e.g. a current) time.

6. The system of claim 4, wherein said cover includes a member such that when said cover is in closed position, said member presses said button.

7. The system of claim 4, wherein said button is located on a side of the housing.

8. The system of claim 4, wherein said predefined lapse of time is approximately zero seconds.

9. The system of claim 4, wherein when said cover is in closed position, an interface corresponding to a notification received by said smartwatch is displayed on at least a portion of the screen in relationship with said window.

10. The system of claim 4, wherein when said cover is in opened, said button is released and accordingly, said smartwatch processor displays a content on a location on the screen regardless of the location of said window within said cover.

11. The system of claim 4, wherein when said cover is in opened, said button is released and accordingly, said smartwatch processor displays a content on practically on an entire portion of the screen regardless of the location of said window within said cover.

12. The system of claim 4, wherein said cover includes a physical wristwatch.
